(19) United States
(12) Patent Application Publication
(10) Pub. No.: US 2021/0295435 A1
(43) Pub. Date: Sep. 23, 2021

(54) PLATFORM AND METHOD FOR MONETIZING INVESTMENT DATA

(71) Applicant: Vault Data, LLC, Westlake, TX (US)

(72) Inventor: Charles A. Langdon, JR., Westlake, TX (US)

(73) Assignee: Vault Data, LLC, Westlake, TX (US)

(21) Appl. No.: 17/207,062

(22) Filed: Mar. 19, 2021

Related U.S. Application Data
(60) Provisional application No. 62/992,049, filed on Mar. 19, 2020.

(51) Int. Cl. G06Q 40/06; G06F 16/2457; G06F 16/2455; G06F 21/31

(52) U.S. Cl. CPC G06Q 40/06; G06F 16/24575; G06F 21/31; G06F 16/24564; G06F 16/24578

(57) ABSTRACT

A system, method, device, and platform for monetizing investment data. Electronic devices execute a data application. The data application is configured to capture user data associated with the user. The platform includes a data platform accessible by the electronic devices. The data platform receives one or more user identifications for a user, authenticates the user, receives one or more user queries, retrieves content associated with the one or more user queries including the investment data, displays the content in a continuous display in which the user is enabled to view any of the content generated during a session by zooming, scrolling, or rotating in multiple dimensions, receives revisions to the one or more queries, retrieves revised content associated with the revisions including revisions to the investment data, and displays the revised content in the continuous display and saving the previous content.

### PRIORITY

This application claims priority to U.S. Provisional Patent Application 62/992,049 filed Mar. 19, 2020 and entitled Platform for Research, Analysis, and Communications Compliance of Investment Data, hereby incorporated by reference in its entirety.

### BACKGROUND

### I. Field of the Disclosure

The illustrative embodiments relate to investment analysis and processing. More specifically, but not exclusively, the illustrative embodiments relate to a network, system, method, apparatus, and platform for identifying, analyzing, processing, utilizing, communicating, and storing investment data.

### II. Description of the Art

Financial managers and investors rely on data to effectively invest, manage investments, perform research, and analyze risk. The time required for experts to process and synthesize data is extensive. Often, individuals and companies work with only 60% of available data with 30% of that data frequently being flawed. Existing investment services and systems often provide data that is overinclusive, outdated, incorrect, or insufficient for the issues being addressed. As a result, many financial managers still rely on manual processes and evaluations to perform research and analysis costing both time, money, and resources.

### SUMMARY OF THE DISCLOSURE

The illustrative embodiments provide a system, method, device, and platform for monetizing investment data. Electronic devices execute a data application. The data application is configured to capture user data associated with the user. The platform includes a data platform accessible by the electronic devices. The data platform receives one or more user identifications for a user, authenticates the user, receives one or more user queries, retrieves content associated with the one or more user queries including the investment data, displays the content in a continuous display in which the user is enabled to view any of the content generated during a session by zooming, scrolling, or rotating in multiple dimensions, receives revisions to the one or more queries, retrieves revised content associated with the revisions including revisions to the investment data, and displays the revised content in the continuous display and saving the previous content.

Another embodiment provides a data platform. The data platform includes a processor for executing a set of instructions and a memory for storing the set of instructions. The set of instructions are executed to receive one or more user identifications for a user, authenticate the user, receive one or more user queries, retrieve content associated with the one or more user queries including the investment data, display the content in a continuous display in which the user is enabled to view any of the content generated during a session by zooming, scrolling, or rotating in multiple dimensions, receive revisions to the one or more queries, retrieve revised content associated with the revisions including revisions to the investment data, and display the revised content in the continuous display and saving the previous content.

Other illustrative embodiments provide a system, method, device, and platform for analyzing investment data, communicating selected data to clients, and documenting such communications to comply with regulatory requirements that govern investment management. One or more identifications for a user are received and authenticated. One or more user queries are received. Content associated with the one or more user queries are retrieved including the investment data. The content is displayed in a continuous display in which the user is enabled to view any of the content generated during a session by zooming, scrolling, or rotating in multiple dimensions. Revisions to the one or more queries are received. Revised content associated with the revisions are retrieved. The revised content is displayed in the continuous display in which the previous content is saved. Another embodiment provides a processor for executing a set of instructions and a memory storing a set of instructions configured to perform the method herein described.

Another embodiment provides a method for processing investment data. One or more user queries are received. Public and private databases and resources with defined data structures are searched utilizing the one or more user queries. Unstructured data is searched utilizing the one or more user queries. Portions of the investment data retrieved in response to searching the defined data structures and the unstructured data are culled. The investment data is sorted by rating and ranking the investment data. Another embodiment provides a processor for executing a set of instructions and a memory storing a set of instructions configured to perform the method herein described.

Another embodiment provides a method for analyzing investment data. Content including the investment data is retrieved from public and private data sources in response to one or more user queries. Associated metadata for original data and republication data is retrieved. Micro and macro investment data is retrieved. The document content is broken down into its underlying essential elements. Each individual element is digitally analyzed by tone, personality, sentiment, keywords and phrases, origin meta data, and variances. Market interactions are determined to communicate changing market dynamics. Changing market conditions are tracked and updated for investments associated with the user based on changes in the investment data. Alerts are sent to the user in response to the changing market dynamics and conditions. Another embodiment provides a processor for executing a set of instructions and a memory storing a set of instructions configured to perform the method herein described.

Another embodiment provides a method for analyzing investment data. Content including the investment data is retrieved from public and private data in response to one or more user queries. Associated metadata is retrieved as part of the content for original data and republication data. Micro and macro investment data is retrieved as part of the content. The content is analyzed for tone, personality, sentiment, keywords and phrases, and variances. Entity interactions are determined to communicate changing market dynamics. Changing conditions are tracked and updated for investments associated with the user based on changes in the investment data. Alerts are sent to the user in response to the changing market dynamics and conditions.

### BRIEF DESCRIPTION OF TILE DRAWINGS

Illustrated embodiments are described in detail below with reference to the attached. drawing figures, which are incorporated by reference herein, and where:

FIG. 1 is a pictorial representation of a system for managing investment data in accordance with an illustrative embodiment:

FIG. 2 is a pictorial representation of a data platform in accordance with an illustrative embodiment:

FIG. 3 is a pictorial representation of a data platform in accordance with an illustrative embodiment:

FIG. 4 is a flowchart of a process for communicating investment data in accordance with an illustrative embodiment;

FIG. 5 is a flowchart of a process for prioritizing the data associated with the one or more user queries in accordance with an illustrative embodiment;

FIG. 6 is a flowchart of a process for analyzing data in accordance with an illustrative embodiment;

FIG. 7 is a flowchart of a process for further analyzing data in accordance with an illustrative embodiment;

FIG. 8 is a pictorial representation of user saved searches in accordance with an illustrative embodiment;

FIG. 9 is a pictorial representation of saved attributes in accordance with an illustrative embodiment;

FIGS. 10-12 illustrate embodiments of a user interface for generating investment data in accordance with illustrative embodiments;

FIG. 13 is a flowchart of a process for updating the system in accordance with an illustrative embodiment;

FIG. 14 is a flowchart of a process for generating investment grade data in accordance with an illustrative embodiment;

FIG. 15 is a pictorial representation of a user interface for implementing queries in accordance with an illustrative embodiment; and

FIG. 16 depicts a computing system in accordance with an illustrative embodiment.

### DETAILED DESCRIPTION OF THE DISCLOSURE

The illustrative embodiments provide a network, system, method, platform and devices for cognitive data processing and management for generating investment grade data. The illustrative embodiments may be utilized to perform research and analysis. Any number of inquiries may be initiated utilizing the system. Content may be generated based on the retrieved data and information. The searched data may include structured and unstructured data. Similarly, the system may search for or utilize public or private data and resources. The system may search for metadata and data embedded within a document. The data analyzes original content, amendments, republications, and other variations of the data. The system breaks the data down into key elements utilizing tone, personality, sentiment, keywords and phrases, keyword and phrase variances, metadata, and so forth.

The illustrative embodiments max reveal micro and macro investment data relating to a query, such as a company, individual, industry, field, peer group, event, or so forth. Complex combinations of data are analyzed in real-time to understand dynamic changes that affect interests, holdings, targets, monitored groups, queries, or so forth. The data may be utilized to quickly identify investment opportunities and weaknesses.

The analysis may be utilized to perform any number of real-world actions, such as transactions, exchanges, alerts, notices, or so forth. For example, the data analysis may be presented and a buy or transaction option may be presented to a user for immediate implementation if accepted. Alternatively, the transaction may be automatically implemented based on user preferences, selections, pre-approvals, or so forth. As a result, the user may only be required to approve the action to move forward (e.g., accepting a transaction buy notice through an application of a smart phone, etc.). The illustrative embodiments may also generate predictive analysis based on machine learning, artificial intelligence, and other logic to facilitate the activities of investors.

One or more unique user interfaces may also be presented to the user presenting analysis, options, and available data. The user interfaces allow the user to more quickly and efficiently navigate available information. For example, alerts, notifications, or messages may be utilized to launch one or more applications to implement a transaction (e.g., buy, sell, etc.), provide a client/investor relevant data, or otherwise perform an action. The user interfaces and methods of implementation offer improvements in speed and functionality over existing systems.

The illustrative embodiments may utilize any number of variables to perform a query, search, or operation to generate and analyze data. In one embodiment, the system may utilize a hidden Markov model to process the data. For example, data may be processed. towards multiple endpoints. In one, the hidden Markov model may be utilized to perform specific learning and analysis associated with a single user. In another, the hidden Markov model may be utilized to perform specific learning and analysis associated with multiple users. The illustrative embodiments may also utilize a data wavefront model to prioritize events. For example, an economic event or change may be analyzed to determine the cumulative impact on associated variables that affect the resulting economic wavefront model thereby providing a different valuation based on the data wavefront model.

The illustrative embodiments may create models that are based on the user's research, analytics, parameters, settings, queries, and so forth. The models may be created utilizing machine learning and/or artificial intelligence. As a result, manual searches performed by the user may be converted into automated processes that may be then repeated for numerous entities, targets, subjects, or queries. The illustrative embodiments are utilized to predict, identify, highlight, and rank, and benchmark data. As previously noted, the user may also specify automated physical and electronic activities that are performed based on the data including real world transactions (e.g., buy, sell, hold, limit, market, short, futures transaction, option, etc.), communications (e.g., alerts, email messages, text messages, notices, in-application messages, etc.), decisions, investments, negotiations, competitive analysis, and so forth. As noted, this information may be presented through a unique user interface. In one embodiment, the user may be presented with options for running analysis previously implemented for a previous target, entity, issue, matter, or client.

The illustrative embodiments may be provided as specialized computing devices or components, software packages, software as a service (SaaS), web or Internet based services, cloud, network, and database services, or so forth. The illustrative embodiments provides stakeholders (e.g., financial services, registered investment advisors (RIAs), investors, potential investors, owners, managers, brokers, investment service providers, etc.) and others the ability to analyze their existing or potential holdings, interests, targets, or competition.

The data may be accessible from any number of authorized and connected devices within the enterprise or mobile networks. The illustrative embodiments allow users/consumers, consumer groups, companies, organizations, entities, governments, and other parties worldwide to develop investment strategies based on efficiently performed data analysis and processing.

As referenced herein, data refers to the investment data, entity profiles, web profiles, search profiles, application profiles, and other information applicable to a company, business, entity, organization user, stock, fund, equity, bond, or other investment. The illustrative embodiments comply with all applicable data privacy and administration rules, laws, statutes, industry standards, and best practices. Any number of mobile devices, computers, machines, servers, arrays, or so forth may be utilized to implement the illustrative embodiments.

In one embodiment, the illustrative embodiments may learn so that a series of data queries may be compressed into a single action. As a result, a single selection (e.g., one click, voice, or text interfaced execution) may be utilized to process a query that develops and displays performance benchmarks across a set of companies and/or over a period of time. The platform utilizes common language queries that may include multiple search criteria within a single query. The queries and results may be visually presented to the user as a 360-degree eco-system perspective. The illustrative embodiments utilize traditional and digital analytic tools to provide responses. The user may view and manipulate the queries and results in real-time utilizing the eco-system 360-degree perspective. The user may enable user to “jump” several levels in their queries. Pre-programmed queries or series of queries may be learned or used as needed. For example, first-level, second-level, and/or n-level responses may be utilized. The queries may be applied to any number of subject matters including companies, people, industries, supply chains, events, and/or portfolios. In another embodiment, the platform may provide all of the relevant information and data on a infinite paper interface. The infinite paper interface appears as a single piece of paper where the different actions may be displayed and mapped (i.e., in a two dimensional space) for one or more users to navigate, pan, zoom, and otherwise view, edit, and navigate portions of the financial research.

Iterative cognitive analysis including analyzing, ranking, sorting, indexing, bench marking, and so forth, and may be utilized to deliver unique results to one or more users. The illustrative embodiments may respond to queries of any complexity utilizing highly focused responses, in particular, relevant data is identified and extraneous data is filtered out to deliver query results. The iterative cognitive analysis may be applied to user searches and queries to find results and responses that go beyond the users expected response to provide enhanced value. The illustrative embodiments may utilize data resources beyond the user's experience, knowledge, resources, or explicit direction to find answers the user did not know to look for. For example, the query itself may be expanded to deliver answers beyond the scope of the original query. The expanded queries may be based on machine learning, artificial intelligence, historical queries and searches, user preferences, and so forth. As a result, the illustrative embodiments may be utilized to provide expanded, but entirely relevant responses, answers, and results.

The illustrative embodiments perform real-time learning and training of one or more models toward predictive or assistive analytics that may be utilized to guide content generation, management, and decision-making. The model may learn utilizing machine learning, artificial intelligence, user preferences/settings/parameters, and so forth. The one or more models may be utilized to execute a set of sub-instructions that may complement or supplement high-level interactions between the user and the system/platform. Real-time learning may be performed across the entirety of the system/platform for multiple users or instances. Machine learning may perform ranking and rating of data, comparative benchmarking of data, decisions, and analyzed information to improve the data and analytics.

The illustrative embodiments may receive, process, collect, and source data from any number of traditional data collection sources, services, and methods, such as online (e.g., websites, mobile applications, user profiles, etc.) and real-world sources (e.g., Bloomberg, etc.). The illustrative embodiments are a considerable improvement over traditional research and analysis methods and systems. These systems are often slow and provide limited data to the user. Oftentimes, the user may also be swamped with unusable or irrelevant data as well.

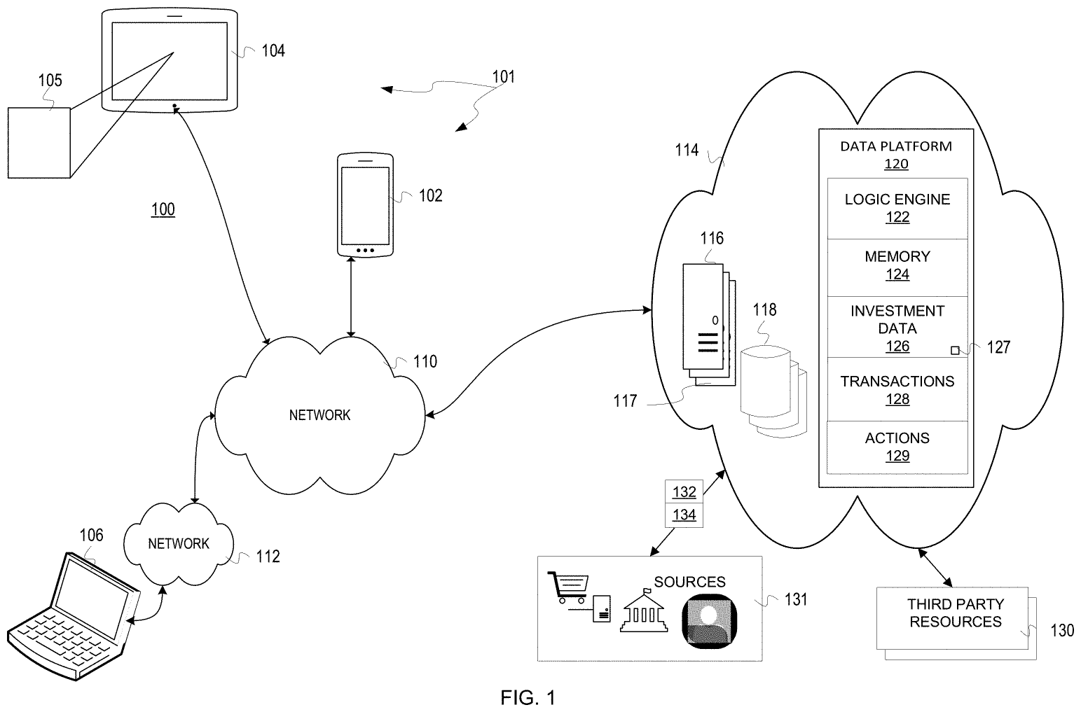

FIG. 1 is a pictorial representation of a system 100 for managing investment content in accordance with an illustrative embodiment. In one embodiment, the system 100 of FIG. 1 may include any number of devices 101, networks, components, software, hardware, and so forth. In one example, the system 100 may include a wireless device 102, a tablet 104 displaying graphical user interface 105, a laptop 106 (altogether devices 101), a network 110, a network 112, a cloud system 114, servers 116, databases 118, a data platform 120 including at least a logic engine 122, a memory 124, investment data 126, tokens 127, and transactions 128. The cloud system 114 may further communicate with sources 131 and third-party resources 130. The various devices, systems, platforms, and/or components may work alone or in combination.

FIG. 1 illustrates a few of the potential devices that may be utilized together to perform the illustrative embodiments. Any timber of other devices, systems, equipment, or components may also be utilized with the system 100. The system 100 may alternatively be referred to as a platform.

Each of the devices and equipment of the system 100 may include any number of integrated, linked, or interconnected computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity,

In one embodiment, the system 100 may be utilized by any number of users, organizations, or providers to analyze, process, aggregate, manage, review, communicate, and utilize investment data 126. The investment data 126 may represent a number of different data types. For example, the investment data 126 may include structured and unstructured data. The investment data 126 may include personal data, commercial data, and other forms of data. The investment data 126 may be utilized to implement transactions 128 or actions 129. The transactions 128 may include utilization or access to all or portions of the services of the system 100. For example, numerous users may pay a daily, monthly, yearly, or search-related fee to utilize the system 100. Any number of payment or compensation schemes may be utilized. The transactions 128 may also include one or more actions performed at the request of a user based on the investment data 126. The transactions 128 may include any number of transactions, such as selling, buying, market orders, limit orders, stop orders, buy stop orders, buy-to-open, sell-to-open, buy-to-close, sell-to-close, and so forth.

In one embodiment, the system 100 may utilize any number of secure identifiers (e.g., passwords, pin numbers, certificates, etc.), secure channels, connections, links, virtual private networks, biometrics, hardware/software/firmware, or so forth to upload, manage, and secure the investment data 126, create a user profile, generate instructions, or perform other activities. The devices 101 are representative of multiple devices that may be utilized by a user or entity, including, but not limited to the devices 101 shown in FIG. 1. The devices 101 utilize any number of applications, browsers, gateways, bridges, or interfaces to communicate with the cloud system 114, platform 120, and/or associated components. The devices 101 may include any number of Internet of Things (loT) devices.

The wireless device 102, tablet 104, and laptop 106 are examples of common devices 101 that may be utilized to capture, receive, and manage investment data 126, perform transactions 128 and actions 129. For example, the various devices may capture data relevant to the user that is subsequently monetized for the benefit of the user (e.g., location, purchases, behavior, web activity, application use, digital purchases, etc.). Other examples of devices 101 may include personal computers, e-readers, vehicle systems, kiosks, televisions, smart displays, monitors, entertainment devices, virtual reality/augmented reality systems, and so forth. The devices 101 may communicate wirelessly or through any number of fixed/hardwired connections, networks, signals, protocols, formats, or so forth. In one embodiment, the wireless device 102 is a cell phone that communicates with the network 110 through a cellular (e.g., 5G, PCS, etc.) connection. The laptop 106 may communicate with the network 112 through an Ethernet, Wi-fi connection, cellular, or other wired or wireless connection.

The investment data 126 may be collected and sourced from any number of online and real-world sources including, but not limited to, clearinghouses (e.g., stocks, credit, bonds, etc.), website traffic and cookie-based analytics, social media and application data. The investment data 126 may represent both public, private, and proprietary data.

The investment data 126 may be captured through social media and applications. Social media data may be utilized to provide real-time polls, surveys, questionnaires, likes and dislikes, feedback, preferences for media content, site traffic, interests, and numerous other commercial, consumer, or business data. Any number of mobile, computing, personal assistant (e.g., Siri, Alexa, Cortana, Google, etc.), or other applications may be utilized. Social media data may be utilized as definitive or anecdotal data.

The investment data 126 may also be captured through publicly available or private data for markets, platforms, services, point of sale (POS) transactions, card transactions, in-person purchase, digital purchases, and purchase histories or traditional data.

The investment data 126 may also include location-based information and communications. An example of static and perennial data points that may be collected include a standard web form, email request form, wireless triangulation, routers/towers/access points reached, proximity beacons, and so forth. The location-based communications may capture data, such as email, consumer/business addresses, phone numbers, and so forth.

The investment data 126 may also include surveys and questionnaires. Responses to surveys and questionnaires may be one of the best ways to gather and document information regarding a particular topic. Information may be sought from experts, managers, or the general public. The ability to gather real-world consumer insights may help complete or round out the investment data 126. The surveys and questionnaires may be performed digitally (e.g., websites, extensions, programs, applications, browsers, texting, or manually (e.g., audibly, on paper, etc.). Responses to surveys and questionnaires may help determine different viewpoints that may be distinct from those of one or more users utilizing the system 100.

The cloud system 114 may aggregate, manage, analyze, and process investment data 126 across the Internet and any number of networks, sources 131, and third-party resources 130. For example, the networks 110, 112, 114 may represent any number of public, private, virtual, specialty (e.g., trading, financial, cryptocurrency, etc.), or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications standards, protocols, and/or architectures including client-server, network rings, peer-to-peer, n-tier, application server, mesh networks, fog networks, or other distributed or network system architectures may be utilized. The networks, 110, 112, 114 of the system 100 may represent a single communication service provider or multiple communications services providers.

The cloud system 114 may utilize commercial cloud services and resources. For example, the cloud system 114 may integrate cloud services from Amazon/AWS, Google, Microsoft (Azure), IBM (Watson), Oracle, Alibaba, or others. Commercial services may be integrated and expanded as needed to provide processing power to the system 100. The cloud system 114 may act as a virtual assistant that may learn from the user, professional analysts, investment firms, and/or others. The logic and analysis steps may be maintained as proprietary or shared between clients that may utilize the system 100.

The sources 131 may represent any number of investment services, clearing houses, web servers, service providers (e.g., trading platforms, credit card companies, transaction processors, etc.), distribution services (e.g., text, email, video, etc.), media servers, platforms, distribution devices, or so forth. For example, the sources 131 may include Thomson Reuters, Bloomberg, Accern, The Weather Channel, Twitter, Linkedin, and others. In one embodiment, the sources 131 may represent the businesses that purchase, license, or utilize the investment data 126, such as investment service provider, fund managers, hedge fund groups, or other applicable parties. In one embodiment, the cloud system 114 (or alternatively the cloud network) including the data platform 120 is specially configured to perform the illustrative embodiments and may be referred to as a system or platform. The illustrative embodiments may be utilized or integrated with retail, commercial, or other trading platforms, such as etrade, TD Ameritrade, Robinhood, InteractiveBrokers, TradeStation, ZacksTrade, Charles Schwab, Fidelity, Ally Invest, Webull, and other developing or future platforms.

The cloud system 114 or network represents a cloud computing environment and network utilized to aggregate, analyze, process, manage, generate, cull, monetize, and distribute investment data 126 and perform the transactions 128 and actions 129. The cloud system 114 may utilize servers 116 and databases 118 to manage the investment data, 126, transactions 128, and actions 129 utilizing secure direct or network communications with the devices 101. In another embodiment, the cloud system 114 may implement a blockchain system for managing the investment data 126, transactions 128, and actions 129. The cloud system 114 allows investment data 126, transactions 128, and actions 129 from multiple businesses, users, managers, or service providers to be managed from a single location or to be otherwise centralized. The cloud system 114 may also represent distributed or multi-point system. In addition, the cloud system 114 may remotely manage distribution, configuration, and operation of software and computation resources for the devices 101 of the system 100. The cloud system 114 may prevent unauthorized access to investment data 126, transactions 128, actions 129, tools, and resources stored in the servers 116, databases 118, and any number of associated secured connections, virtual resources, modules, applications, components, devices, or so forth. In addition, a user may more quickly submit queries, perform searches, analyze data, upload, aggregate, process, manage, cull, view, and distribute investment data 126 (e.g., investment profiles, updates, surveys, content, etc.), transactions 128, and actions 129 where authorized, utilizing the cloud resources of the cloud system 114 and data platform 120.

The cloud system 114 allows the overall system 100 to be scalable for quickly adding and removing users, businesses, authorized parties, algorithms, models, interest-based information, transaction-based information, analysis modules, distributors, valuation logic, algorithms, moderators, programs, scripts, logic, filters, transaction processes, or other users, devices, processes, or resources. Communications with the cloud system 114 may utilize secure identifiers (e.g., passwords, pins, keys, scripts, biometrics, etc.), encryption, secured tokens, secure tunnels, handshakes, firewalls, digital ledgers, specialized software modules, or other data security systems and methodologies.

The servers 116 and databases 118 may be integrated with or represent a portion of the data platform 120. In one embodiment, the servers 116 may include a web server 117 utilized to provide a website, mobile applications, and/or user interface (e.g., user interface 107) for interfacing with numerous users. Information received by the web server 117 may be managed by the data platform 120 managing the servers 116 and associated databases 118. For example, the web server 117 may communicate with the database 118 to respond to read and write requests, queries, searches, and other operations. For example, the servers 116 may include one or more servers dedicated to implementing and recording research and analysis sessions, communicating/displaying the sessions and the associated content and investment data, sending or displaying communications, messages, or alerts, or performing one or more actions (e.g., financial transactions).

For example, the databases 118 may store a digital record or ledger for all queries, searches, and updates performed for the investment data 126, transactions 128, and actions 129 monitored, queued, scheduled, tracked, and/or performed. The servers 116 may perform specialized messaging through discrete messages or in-application messages.

The databases 118 may utilize any number of database architectures and database management systems (DBMS) as are known in the art. The databases 118 may store the content including the investment data 126, transactions 128, actions 129 and/or other relevant information. Any number of security mechanisms or secure identifiers, such as secure interfaces, passwords, virtual private networks/connections, encryption schemes, serial numbers, or so forth may be utilized to ensure that content, personal, or transaction information is not improperly shared or accessed.

The user interface 105 may be made available through the various devices 101 of the system 100. In one embodiment, the user interface 105 represents a graphical user interface, audio interface, touch/tactile interface, telephonic interface, or other interface that may be utilized to manage queries, searches, sessions, investment data 126, transactions 128, actions 129, or other information. For example, the user may enter or update associated data utilizing the user interface 105 (e.g., browser or application on a mobile device). The user interface 105 may be presented based on execution or implementation of one or more specialized or default applications, browsers, kernels, modules, scripts, operating systems, or specialized software that is executed by one of the respective devices 101. In addition, the user interface 105 may display information that may be utilized to initiate, open, or execute specific applications, webpages, processes, or so forth.

The user interface 105 may display current queries/searches, content, and investment data, and historical investment data as well as trends. The user interface 105 may be utilized to set the user preferences, parameters, and configurations of the devices 101 as well as upload and manage the data, content, and implementation preferences, settings, parameters, scripts, and algorithms sent to the cloud system 114. The user interface 105 may also be utilized to communicate the investment data 126, transactions 128, and actions 129 to the user. The devices 101 (e.g., displays, indicators/LEDs, speakers, vibration/tactile components, etc.) may present, play, display, or otherwise communicate the actions 129 visually, audibly, tactilely, or any combination thereof as a communication session, discrete messages, or so forth.

In one embodiment, the system 100 or the cloud system 114 may also include the data platform 120 which is one or more devices utilized to enable, initiate, generate, aggregate, analyze, process, and manage investment data 126, transactions 128, actions 129, and so forth with one or more communications or computing devices. In another embodiment, the data platform 120 may also represent one of the servers 116 and the memory 124 may represent the databases 118. The data platform 120 may include one or more devices networked to manage the cloud network and system 114. For example, the data platform 120 may include or represent any number of servers, routers, switches, or advanced intelligent network devices. The data platform 120 may represent one or more specialized or standard web servers that perform the processes and methods herein described. The cloud system 114 may securely manage communications of relevant data.

In one embodiment, the logic engine 122 is the logic that controls various algorithms, programs, hardware, and software that interact to receive queries/searches, aggregate, analyze, rank, rate, process, score, communicate, and distribute investment data, content, transactions, actions, alerts, reports, messages, or so forth. The logic engine 122 may utilize any number of thresholds, parameters, criteria, algorithms, instructions, or feedback to interact with authorized users and to perform other automated processes. In one embodiment, the logic engine 122 may represent a processor or processing device. The processor is circuitry or logic enabled to control execution of a program, application, operating system, macro, kernel, or other set of instructions. The processor may be one or more microprocessors, digital signal processors, application-specific integrated circuits (ASIC), central processing units, quantum circuits, or other devices suitable for controlling an electronic device including one or more hardware and software elements, executing software, instructions, programs, and applications, converting and processing signals and information, and performing other related tasks. The processor may be a single chip or integrated with or in communication with other computing or communications elements.

The memory 124 is a hardware element, device, or recording media configured to store data for subsequent retrieval or access at a later time. The memory 124 may be a static or dynamic memory. The memory 124 may include a hard disk, random access memory, cache, removable media drive, mass storage, or configuration suitable as storage for investment data 126, transactions 128, actions 129, instructions, and information. In one embodiment, the memory 124 and logic engine 122 may be integrated. The memory 124 may use any type of volatile or non-volatile storage techniques and mediums. In one embodiment, the memory 124 may also store a digital ledger and tokens for implementing blockchain processes. For example, the investment data 126 may be released (e.g., secure file transfer, secure file access, pointers, encrypted information, etc.) in exchange for payment of tokens in exchange for a payment, subscription, compensation, exchange, or other transaction.

In one embodiment, the cloud system 114 or the data platform 120 may coordinate the methods and processes described herein as well as software interactions, synchronization, communication, and processes. The third-party resources 130 may represent any number of human or electronic resources utilized by the cloud system 114 including, but not limited to, data services, businesses, independent consultants, entities, organizations, individuals, government databases, private databases, web servers, research services, and so forth. For example, the third-party resources 130 may represent exchanges, data providers, brokerages, hedge fund groups, private investment groups, advertisement agencies, marketers, e-commerce companies, verification services, credit monitoring services, block chain services, payment providers/services, and others that pay for rights to use the investment data 126, track or provide information regarding the transactions 128, and create, implement, or monitor utilization of the actions 129.

The data platform 120 may interact with third-party resources 130 using any number of secure connections or interfaces, such as application program interfaces (APIs). The third-party resources 130 may represent any number of congressional bills, video news content, audio news content, blogs, analyst newsletters, Federal Reserve Economic Data (FRED), Freedonia. Securities and Exchange Commission (SEC) compliance documentation guidelines, customer relationship management (CRM) packages, mobile distribution chains, and so forth.

The data platform 120 may cross-reference updates, changes, or other modifications to the investment data 126 with an original record (or earlier release) for the data platform 120 to ensure proper documentation, maintenance, control, and management. Different sessions, queries, and searches may be saved in the memory 124 for subsequent access and analysis. For example, a sequence of queries, filters, and narrowing information may be saved to redo the search at a later time. The illustrative embodiments provide a system 100, cloud system 114, and data platform 120 for generating and analyzing investment data 126 regarding stocks, equities, ownership, holdings, and interests, to generate investment grade data that may be utilized to automatically or manually perform transactions 128 and/or actions 129. The illustrative embodiments are performed based on the user's request, authorization, or approval to apply with all applicable laws and industry standards.

The data platform 120 may also utilize any number of payment systems (e.g., PayPal, Venmo, Dwolla, Square, wire transfers, credit cards, Quicken, etc.) to receive money to access the data platform 120 and perform searches. In one embodiment, the data platform 120 may receive a subscription fee, per query/search fee, hourly fees, small tee or percentage per transaction, data uploaded/updated., data purchased, shared, or licensed, purchased item, browsing session, or so forth. Any number of different subscription services, software as a service (SaaS), or other monetization methods may be utilized to provide, access, or manage the content and investment data herein described. In one embodiment, the data platform 120 may be utilized to verify users (as well as other users/entities that utilize the data platform 120) and associated investment data 126, transactions 128, and actions 129 associated with the investment data 126.

The third-party resources 130 may represent any number of electronic or other resources that may be accessed to perform the processes herein described. For example, the third-party resources 130 may represent government, private, and public servers, databases, websites, programs, services, and so forth for verifying the investment data 126, transactions 128, and the actions 129. In another example, auditors may verify the actions 129 are actually generated based on the investment data 126 (e.g., including the transactions 128).

Various data and venue owners that access the data platform 120 may legally extract and tokenize the investment data 126, transactions 128, and advertisements for use in the exchange provided by the system 100 by identifying and tracking data utilizing automatic data extraction tools. Any number of privacy and data policies may be implemented to ensure that applicable local, State, Federal, and International laws, standards, and best practices and procedures are met.

The illustrative embodiments may also support third-party access and utilization of the investment data 126 and transactions 128 to generate the actions 129. Various authorization, auditing, and validation processes may be performed by internal auditors, external auditing groups, commissions, industry groups, or other professionals/entities.

In one embodiment, the logic engine 122 may utilize artificial intelligence (AI). machine learning (ML), and customized algorithms, scripts, and logic. The artificial intelligence and machine learning may be utilized to enhance investment data 126, analyze transactions 128, and generate actions 129 to increase value, utilization, effectiveness, and profits. For example, artificial intelligence may be utilized to review, authenticate, and validate data and transactions that are received by the system 100. The artificial intelligence of the logic engine 122 may be utilized to ensure that the investment data 126 is improved, accurately analyzed, and value increased. For example, the user may rate and rank the results of the query/search each time they are performed so that the logic engine 122 of the data platform 120 may learn over time.

In another embodiment, the devices 101 may include any number of sensors, applications, and devices that utilize real time measurements and data collection to update the investment data 126. For example, a sensor network (e.g., microphones, cameras, etc.) may determine the sentiment and attitude of trading floors, brokerages, public spaces, and so forth. This nontraditional data may also be utilized to generate and analyze the investment data 126.

In one embodiment, the data platform 120 may extract data from third-party platforms by opting in and providing user credentials to various applications (e.g., Charles Schwab, TD Ameritrade, E*Trade, Vanguard, Fidelity, Merrill Lynch, Bloomberg, etc.) the data platform 120 may extract data from the sources 131.

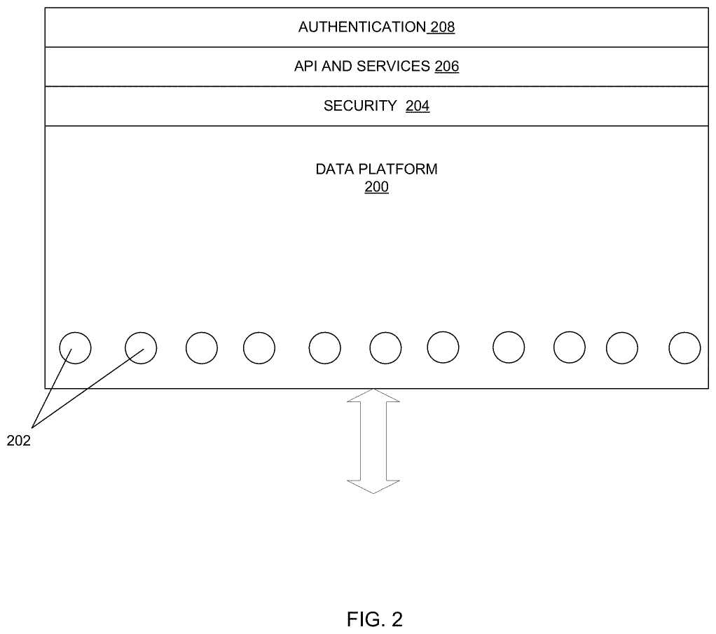

FIG. 2 is a pictorial representation of a data platform 200 in accordance with an illustrative embodiment. In one embodiment, the data platform 200 is one example of the data platform 120 of FIG. 1. The data platform 200 processes communications 202 to and from a number of internal and external sources. The communications 202 may represent both inputs and outputs. The communications 202 may represent distinct data that is processed, analyzed, generated, reported, and otherwise communicated.

The data platform 200 may include modules, components, hardware, and/or software for security 204, APIs and services 206, and authentication 208.

The authentication 208 ensures that users, devices, or connections to the data platform 200 are identified, authorized, documented, and secured for secure communications. The authentication 208 establishes authentication for users and devices and session management before any access is allowed. The authentication 208 may utilize any number of identifiers, passwords, keys, tokens, encryption schemes, secure connections, handshakes, or other processes to authenticate, authorize, and secure communications with the data platform 200 including processing, analysis, and generation of the associated investment data.

The security 204 secures communications to and from the data platform 204. The security 204 may protect the memory, processor, systems, and components of the data platform 200. The security 204 may validate input data (e.g., files, parameters, HTTP headers, cookies, metadata, etc.) received in the communications 202 before storing or using the data. The security 204 may parameterize database statements to prevent injection attacks. The security 204 may process the communications 202 to encode the data and information before processing the information to prevent other injection attacks. The security 204 may deny by default access to the data platform 200 unless authorized by the authentication 208. For example, the security 204 may control encryption of data in transit, when stored, and during processing (e.g., SSL/TTS, transport layer protection, etc.). The security 204 may also performing logging and intrusion detection for the data platform 200.

The APIs and services 206 manages the interactions and communications 202 with outside devices, software, systems, equipment, and components. In one embodiment, a mobile application operated by an authorized user on an associated wireless device may be utilized to interact with the data platform 206. In addition, external services may interact with the APIs and services 206 to send and receive the communications for receiving, generating, and processing investment data. The data platform 200 may process structured or unstructured data to generate the investment data.

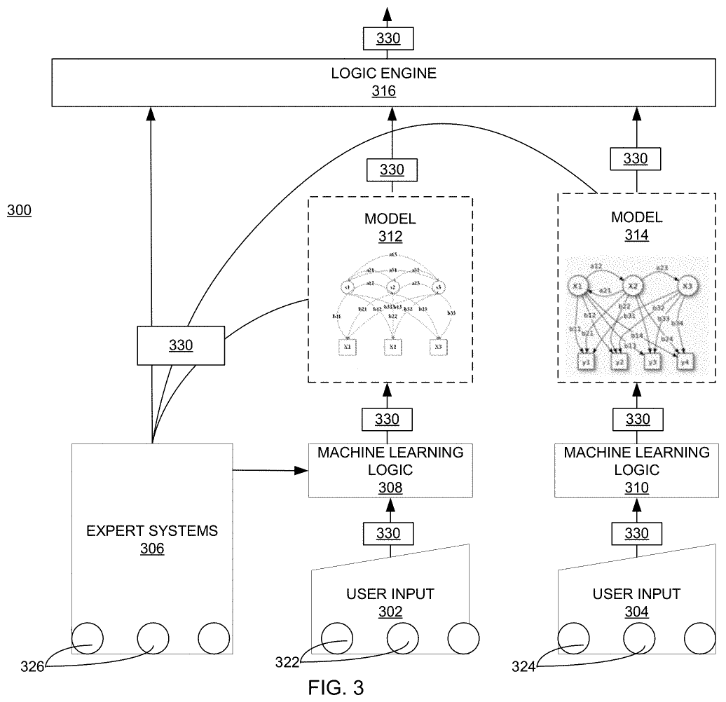

FIG. 3 is a pictorial representation of a data platform 300 in accordance with an illustrative embodiment. In one embodiment, the data platform 300 may include user inputs 302, 304, and expert systems 306. The data platform 300 may represent any portion of grouping of the system 100 of FIG. 1 (e.g., data platform 120, logic engine 122, cloud system 114, etc.).

The data platform 300 may process inputs 322, 324, 326 representing data, information, and variables from the user input 302, 304, and expert system 306. The inputs 322, 324, 326 may change at any time and in real-time affecting investment data 330 that is retrieved, generated, revised, processed, culled, and otherwise modified to generate output for one or more users. Additional inputs (not shown) may also be received from any number of sources. For example, non-specific data may be received by the user inputs 302, 304 or expert systems 306. Established connections and processes for receiving and storing the additional inputs may be implemented for processing by the system 100.

The user input 302 and 304 is analyzed by machine learning logic 308, 310 and models 312, 314 before the investment data is sent to the logic engine 316 for additional analysis and processing. The various inputs 322, 324, 326 may create a virtual search or operation boundary for the data platform 300. The various inputs 322, 324, 326 may represent input variables and operational variables that may be received by the data platform 300. The inputs 322, 324, 326 may represent automatic entries based on previous queries/inputs, saved queries/inputs, or manually selected inputs, data, and information.

The inputs 322, 324, 326 may represent any number of variables used for searches or queries that may be structured or unstructured. The inputs 322, 324, 326 may be entered through a user interface, application, web interface, program, application program interface (API), personal computer, smart phone, or other device or interface. The inputs 322. 324, 326 may be received from one user or multiple users, extracted from previous investment data, or otherwise retrieved, determined, or generated.

The expert systems 306 and user inputs 302, 304 may perform pre-processing, aggregation, and query analysis. The expert system 306 may represent any number of existing systems or services utilized to receive input 326. The input 326 may represent existing investment and financial data that is generated or gathered by the expert systems 306. The models 312, 314 may utilize hidden Markov model (HMM) that process the investment data utilizing a Markov process to determine unobservable (or hidden) dates associated with the investment data 330. The Markov process is a stochastic model describing a sequence of possible events in which the probability of each event depends only on the state attained in the previous event in real time. Any number of information or data points associated with a potential investment 330 (i.e., investment data) may be sampled as part of the mathematic, statistic, or logical processes, systems, and models utilized by the models 312, 314.

The expert system 306 and machine learning logic 308, 310 may be utilized to perform categorization and decision making. The data platform 300 may perform real-time learning and training of the models 312, 314 so that predictive, artificial intelligence, and/or assistive analytics may assist content generation, management, and decision-making performed by the data platform 300. The models 312, 314 may longitudinally learn across multiple users or instances of the data platform 300. In one embodiment, the machine learning may perform clustering for the user inputs 302, 304 and investment data 330. The machine learning logic 308, 310 and models 312, 314 may utilize machine learning, artificial intelligence, scripts, or algorithms (whether system or user generated) to identify, predict, rank, and rate the investment data that is generated based on the inputs 322, 324, 326. Over time, the ranking and rating data that is performed automatically or based on user feedback and input may provide information and data that may extensively tune the performance and analysis of the data platform 300 including the machine learning logic 308, 310 and the models 312, 314. The models 312, 314 may utilize a Hidden Markov Model implementation for the investment data. The machine learning logic 308, 310 and models 312, 314 may utilize any number of variables, settings, parameters, and configurations for performing analysis and processing.

In one embodiment, each query may be utilized by the data platform 300 (e.g., machine learning logic 308, 310, models 312, 314) to create and capture a breadcrumb, that corresponds to a saved searches and question within a query. The breadcrumb may also represent the resources that are searched. The breadcrumbs are archived under a saved name so that the user may instantly recall a successful search or series of searches. The user may edit breadcrumbs to change one or any number of query variables to create new queries without having to start from scratch. Query results and conclusions may be compared and bench marked one versus the other for data quality and outcome probability. For example, ratings and rankings may be utilized to determine the best and most effective queries. A user may apportion investment decisions and funds across multiple queries for weighted investments. The machine learning logic 308, 310 may find other relevant data and opportunities, such as a short thesis, long thesis, debt thesis, consumer thesis, consumer thesis, commercial thesis, retail thesis, commodities, and so forth. The machine learning logic 308, 310 may be utilized to scour data for risk and reward-based opportunities that reflect their specific user investments model, disciplines, processes, and strategies. The models 312, 314 may execute logic or instructions/sub instructions to complement or supplement high-level interactions with the data platform 300.

In one embodiment, the user input 302 may correspond to user specific inputs, variables, and analysis and the user input 304 may correspond to multiple user curated inputs, variables, and analysis. The data platform 300 may utilize sequential, parallel, or concurrent analysis of investment data.

The logic engine 316 may perform additional decisions based on the fusion of investment data. The logic engine 316 may perform reliability scoring and state classification for the received investment data. The machine learning logic 308, 310, models 312, 314, and/or logic engine 316may analyze speech, tone, variable analysis, and the other portions of the investment data 330 as is described herein.

The logic engine 316 or other portions of the system 300 may utilize a data wavefront model to prioritize events within broad events. In one example, the system may 1) detect an economic event or change, 2) determine a cumulative impact on associated variables, 3) determine a resulting economic wavefront, and 4) determine the effect on a valuation wavefront affecting an investment. Information, alerts, or communications regarding the wavefront may be communicated with one or more actions being implemented as needed.

The investment data 330 may be updated or revised at any time by the system 300. Additionally, the inputs 322,324, 326 may be utilized to change, update, modify, filter, limit, ignore, or otherwise process all or portions of the investment data 330. The system 300 may utilize different decision layers to process the investment data 300 (e,g., pre-processing, aggregation and queries, 1) categorization and decision making, 2) model analysis, and scoring and state classification).

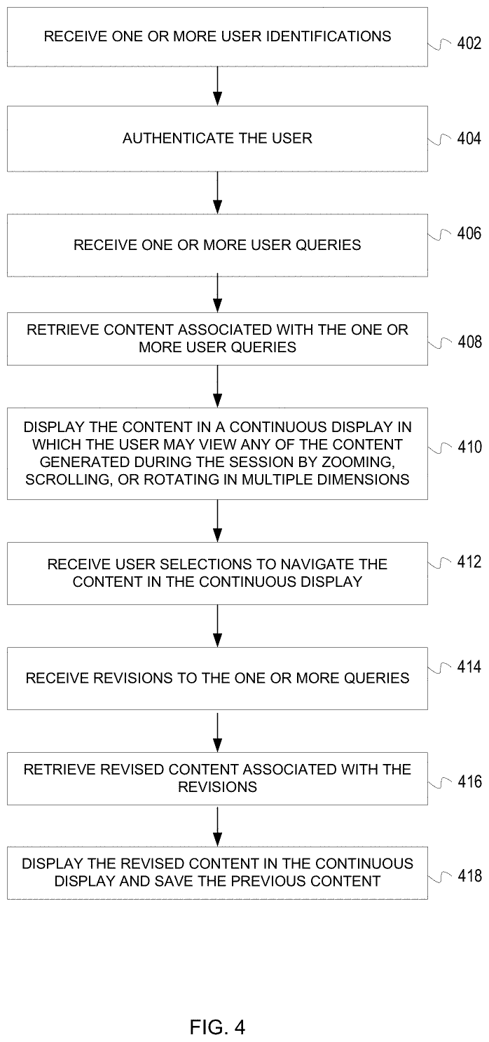

FIG. 4 is a flowchart of a process for communicating investment data in accordance with an illustrative embodiment. The process of FIGS. 4-7, 13, and 14 may be implemented by a system or platform, such as the system 100, data platform 120, or devices 101 of FIG. 1, data platform 200 of FIG. 2, or data platform 300 of FIG. 3, referred to generically herein as the platform. The steps of FIG. 4-6 may be combined in any order, integrated, or otherwise combined as useful.

The process of FIG. 4 may be implemented by a system, platform, or device. One or more user interfaces may be presented to the user for receiving and communicating applicable information. The order of the various steps, processes, and methods performed in FIGS. 4-7. 13, and 14 may be mixed, changed, combined, nested, and so forth. The process of FIG. 4 may begin by receiving one or more user identifications (step 402). The user identifications may be login information, such as username, password, pin, identifying image, or other applicable information. The system may utilize a single, two-part, or multifaceted identification process. For example, confirmation pin numbers, keywords, or other information may be sent to a device, application, or other component associated with the user to identify the user. Any number of biometrics including fingerprints, eye scans, facial recognition, or other information may also be utilized.

Next, the system authenticates the user (step 404). The user identifications and other data and information provided during step 402 may be utilized to perform the authentication. In one embodiment, the user may have a personal profile or business profile that provides distinct information. The profile may specify information, such as settings, parameters, configurations, preferences, scripts, preprogrammed information, and so forth. The profile may be utilized to present custom information based on the user's requirements, past search results, analysis, queries, historical data, or so forth.

Next, the system receives one or more user queries (step 406). The queries may be associated with any number of companies, entities, individuals, technologies, technical fields, industries, or so forth. The queries may be received sequentially, concurrently, or simultaneously. The queries may be keywords, names, identifiers, numbers, codes, or other data and information. The queries may be simple, complex, advanced, Boolean, or so forth. As a result, a user may be able to get broad or narrowly tailored search results. In some embodiments, receiving one or more queries may be performed multiple times until the desired level of detail is specified. In one embodiment, the process of step 406 may be performed automatically in response to companies, entities, groups, or other targets that have been mentioned in writing/text, audibly, or otherwise by one or more authorized users. The system may automatically generate and/or implement queries based on competitors, incoming requests, or other available information. The process of steps 402 and 404 may be implemented for the user based on current certificates or authentications.

Next, the system retrieves content associated with the one or more user queries (step 408). The content may be retrieved utilizing any number of database, webpage, intranet, and other searches of proprietary, private, and/or public information that is tracked or accessible to the system. In one embodiment, the system may retrieve content utilizing the unique processes herein described.

Next, the system displays the content in a continuous display in which the user may view any of the content generated during the session by zooming, scrolling, or rotating the content (step 410). The continuous display has also been referred to as infinite paper in which the two-dimensional space available for displaying one or more user queries, content, analysis, and results may expand as needed. Any of the information or data received or communicated during any parts of the process of FIG. 4 (or the other Figures) may be viewed. The content they may be uniquely navigated to more quickly retrieve applicable information and to revise queries as needed to take advantage of the full processing and analysis abilities of the system. The content may be associated with the files, information, and data retrieved by the system in any type, format, or category.

Next, the system receives user selections to navigate the content in the continuous display (step 412). The selections may be textual, audio, manual (e.g., finger swipes, taps, expansions, etc.), physical, or other selections. For example, the user selections may be received through any number of peripherals associated with a device utilized by the user.

Next, the system receives revisions to the one or more queries (step 414). At any time, the user may provide additional information to the system. For example, the user may revise the information that is analyzed or processed by the system. The revisions may include adjustments, modifications, or new data and information altogether. In addition, the data utilized by the system may be updated in real-time. As a result, any new information may be utilized to revise the query as received. The system may monitor queries that have been performed to provide information as needed based on the “in process” queries that are given priority attention.

Next, the system retrieves revised content associated with the revisions (step 416). As noted, the revisions may be received from the user or from the data, information, and sources utilized by the system. For example, the revised content may be automatically retrieved in the background based on changes associated with the one or more queries that are determined and detected without the user's prior knowledge. In some embodiments, the one or more queries (including revisions) associated with the process of FIG. 4 may be saved and performed automatically with differences being highlighted for authorized users. For example, the content may be retrieved across multiple devices or processors when resources are underutilized to provide additional benefits. Previous queries may be rerun at night when processing utilization is low.

Next, the system displays the revised content in the continuous display and saves the previous content (step 418). The user preferences may specify how the revisions are implemented. For example, the continuous display may be updated from the point of the revised information as a new version, a new branch of the continuous display may be created showing the original content and the revised content, or the revised content may be otherwise communicated.

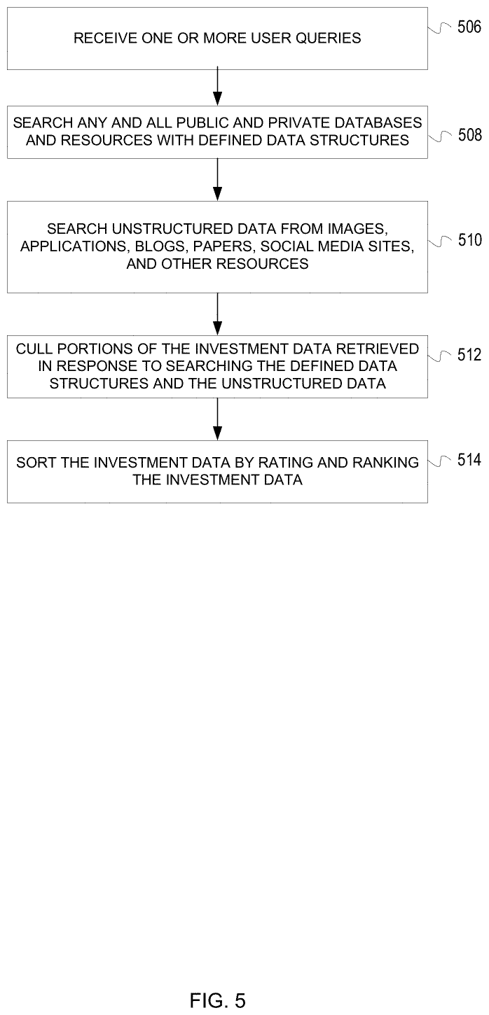

FIG. 5 is a flowchart of a process for prioritizing the data associated with the one or more user queries in accordance with an illustrative embodiment. The process of FIG. 5 may begin by receiving one or more user queries (step 506). The user queries may be original queries or revised queries as previously noted. The user queries may be received as custom selections or selections from menus, available fields/data, and so forth. In one embodiment, the original query or queries received during step 506 may be expanded to cover content and analysis that go beyond the user's original query. Artificial intelligence, machine learning, historical search results, user preferences, analyst feedback/ratings, and other information may be utilized to expand the original query. As a result, the scope of the original query may be expanded (the original query results and expanded query results may be shown together or independently). The process of FIG. 5 may represent additional details regarding at least steps 408 and 416 of FIG. 4.

Next, the system searches any and all public and private databases and resources with defined data structures (step 508). The system may utilize iterative cognitive analysis to search the resources. The system may search any number of databases (e.g., public, private, paid, industry, government, etc.), servers, applications, websites, social media, user/company generated data, data devices, services (e.g., investment services, analyst newsletters, industry services/resources, etc.) and so forth to find content applicable to the one or more user queries. The system may automatically add or remove resources at any time to provide the optimal analysis and results for the query. In other embodiments, the user may limit or filter the resources that are utilized using positive or negative requirements, settings, parameters, and stipulations. For example, the system may be instructed to remove specific resources from the query.

Next, the system searches unstructured data from images, applications, blogs, papers, social media sites, and other resources (step 510). The system may utilize any number of specialized or custom searching tools (e.g., quantum computing, hardware, algorithms, programs, scripts, etc.) to perform the searching of step 510. The structured and unstructured searches of steps 508 and 510 may be performed separately or together. Next, the system culls portions of the investment data retrieved in response to searching the defined data structures and the unstructured data. The system may remove data that is determined to be inapplicable, extraneous, noisy, distractive/false, or otherwise not relevant to the one or more user queries. Feedback and instructions from the user may be utilized to cull the data. The culling process may be utilized to automatically cull future data and results to provide the most relevant information. User preferences, machine learning, and artificial intelligence may be utilized to perform step 512. In one embodiment, the user may manually cull inapplicable data. The system may learn from the user to cull specific data, give it a lower priority, or mark the data as culled data.

Next, the system sorts the investment data by rating and ranking the investment data (step 514). The different data may be prioritized through ranking and sorting. In one embodiment, the data may be communicated or displayed based on the sorting and prioritization that are performed during step 514. The system may automatically perform the steps of FIG. 5, in one embodiment, the user may rate, rank, and sort the data. The data results and resources that are most frequently highly rated by one or more users or systems may be given added priority for future queries so that the system iteratively adapts, evolves, and is optimized to provide the best results applicable to each user.

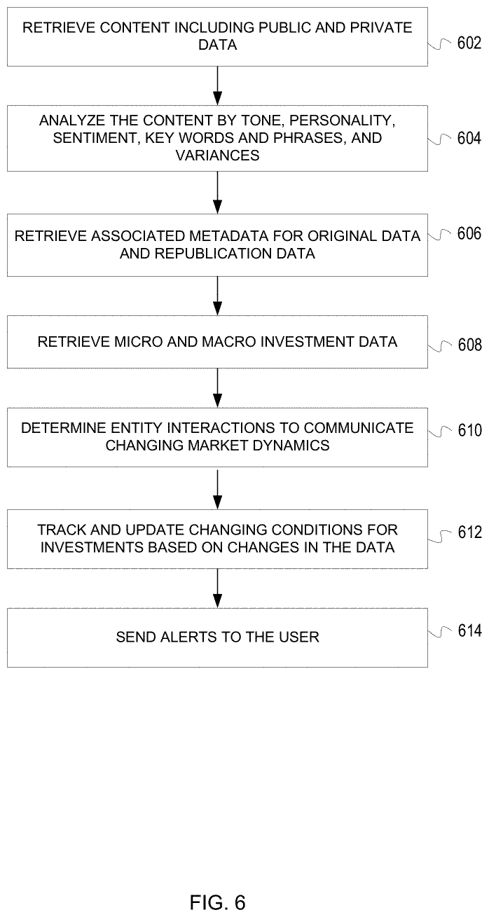

FIG. 6 is a flowchart of a process for analyzing data in accordance with an illustrative embodiment. The process may begin by retrieving content including public and private data (step 602). The content may be based on any number of queries. As previously noted, the data may represent structured and unstructured data. The data may also be gathered from any number of sources. As noted, any number of search or query processes may be utilized to generate and/or retrieve content.

Next, the system analyzes the content by tone, personality, sentiment, keywords and phrases, and variances (step 604). Artificial intelligence and machine learning may be utilized to perform the process of step 604. For example, the system may automatically determine the applicable information. In other embodiments, the system may request opinions, submissions, selections, or other information from experts, professionals, interested parties, the general public, or others. The system may track any number of words and phrases as well as the associated tone, personality, and sentiment associated with those keywords and phrases. The associations may be automatically determined or may be initially assigned by one or more users for subsequent usage. As a result, the system learns automatically and based on user interactions with the system to become more efficient over time.

Next, the system retrieves associated metadata for original data and republication data (step 606). The metadata may include origin, geographic, creation, and publication data associated with the original data and republication data. For example, the users may need to be able to determine whether the data came from the United States, Canada, Russia, Chile, Australia, or China (or other applicable countries or resources). The user may also need to determine the interests of the user. The metadata may include search engine optimization stack ranking that may help the user discern legitimate news sources from questionable/fake news sources. The metadata may also utilize personality analytics of the original content/data and modifications of the data. The user may apply author known and unknown personality analytics to determine whether the author's names changes changed or style and content (e.g., a different author generated content under the original author's name).

Next, the system retrieves micro and macro investment data (step 608). The micro and macro investment data may include a large range of data from financial data points and ratios for one or more companies over multiple time periods including news, stock tweets FRED, SEC, FED, and unlimited user-defined databases with proprietary data that may be accessed through protected servers, systems, drives or proprietary or private systems and networks. Other data, such as legislative, regulator, speculative, politics, weather, and other information that may affect the data may also be retrieved. The system may process data that is legitimate and legal.

Next, the system determines entity interactions to communicate changing market dynamics (step 610). The system may determine relationships (e.g., manufacturing, wholesaling, distributing, selling/reselling, servicing, affiliation, etc,), partnerships, agreements, conflicts (e.g., disputes, arguments, litigation, arbitration, mediation, protests, etc.), and other applicable information. Any number of resources including legal documents, business news, official reporting, and other data may be utilized to determine entity interactions, relationships, affiliations, partnerships, referrals, or so forth. The system may also track the changes in real-time, periodically, or as data becomes available.

Next, the system tracks and updates changing conditions for investments based on changes in the data (step 612). The system may track and update changes separate from any session performed for a user. For example, the system may operate independent of any user sessions to track and update changes for one or more investments. The changes may be updated in real-time. In another embodiment, tracking and updating changing conditions may be separate steps.

Next, the system sends alerts to the user (step 614). The alerts may be sent to any number of users, devices applications, or so forth as specified by the user (e.g., user selection, user preferences, settings, parameters, legal requirements, etc.). For example, the user may specify that relevant alerts are sent to one or more devices (e.g., smart phone, digital assistants, laptops, etc.). The alerts may be distinct messages or communications, such as email messages, text messages, or so forth. The alerts may also be in-application messages, web messages, audio messages, chat messages, or so forth.

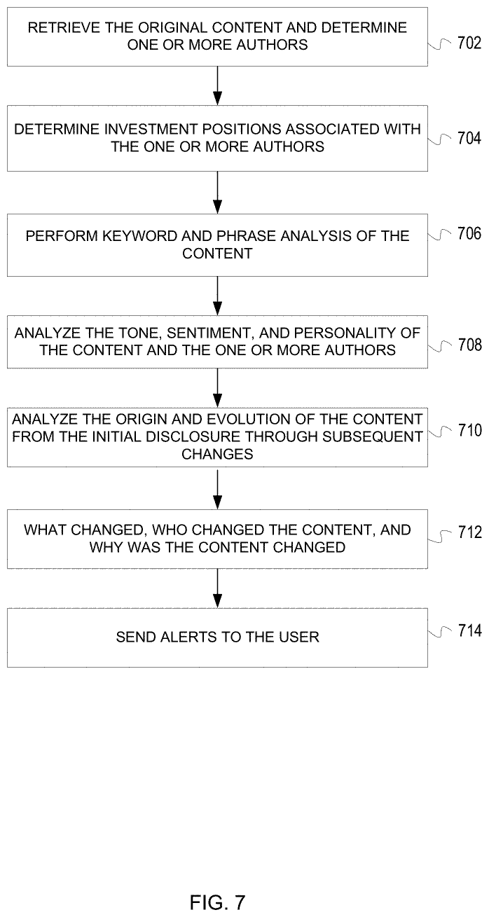

FIG. 7 is a flowchart of a process for further analyzing data in accordance with an illustrative embodiment. As previously noted, the applicable information. The process may begin by retrieving the original content and determining one or more authors (step 702). The authors may represent any number of individuals, groups, entities, parties, or content generators responsible for the content. The system may also determine authors or other parties that are responsible for changes in the content.

Next, the system determines investment positions associated with the one or more authors (step 704). The one or more authors may be required to disclose investments held as part of applicable laws, rules, company practices, industry standards, or best practices. In some embodiments, the system may request additional information from the one or more authors regarding their investments. Step 704 helps determine any potential bias, positions, or influences relevant to the one or more authors.

Next, the system performs key word and phrase analysis of the content (step 706). The system may determine the words utilized by the one or more authors in the content (original or modified). The system may determine the frequency with which keywords and phrases appear in the original (or modified) content.

Next, the system analyzes the tone, sentiment, and personality of the content and the one or more authors (step 708). The analysis performed during step 706 may be utilized to analyze the tone, sentiment, and personality of the content and one or more authors. For example, certain words may convey a positive, negative, neutral, or indifferent tone. The combination of these word usages may indicate the overall sentiment of the content and the author. The system may analyze the author's body of work to determine commonly used words and phrases to determine how the content differs from the author's standard content.

Next, the system analyzes the origin and evolution of the content from the initial disclosure through subsequent changes (step 710). The system analyzes the changes that were made to the original content to determine whether the changes are substantive, corrective, minor, or indicate additional information. The process of steps 706 and 708 may be performed again during step 710 for the new content.

Next, the system determines what changed, who changed the content, and why the content was changed (step 712). Step 712 may be performed in response to determining or detecting changes to the content (e.g., step 710). The information and data determined during step 712 may be utilized to provide relevant information and data that may be associated with the original content, revisions, versions, derivative work, and/or associated content. Changes in content can have very importance significance especially as it relates to investment data, legal reporting, and other applicable information.

Next, the system sends alerts to the user (step 714). The alerts may be messages, alerts, or communications that are discretely communicated or sent through one or more browsers or applications. The alerts may include information and data relevant to the original content or changes. The alerts may provide any of the information determined during the processes and methodologies of the described embodiments.

In other embodiments, one or more mobile applications, programs, scripts, or APIs may be installed or integrated with any number of platforms, programs, or so forth. The API may also be any number of software programs, scripts, modules, sets of instructions, or so forth. In one embodiment, the API may be integrated with a web browser as an add-in, extension, or other interface. For example, the API may be integrated with a search tool (e.g., standalone, browser-based, network managed, etc,) to provide investment data. The API may be utilized by investors, fund managers, risk professionals, individuals, corporations, and data exchange companies to enhance their data protection and data management and monetization strategy. The illustrative embodiments are an improvement over existing technologies because the embodiments allow investment data to be better and more quickly researched and vetted for future, existing, or potential investments.

The platform may also receive a user profile. The user profile may represent an individual, entity, company, organization, or entity and may be referred to generally as a “user profile”, “investment profile”, or “data profile,” For example, a user profile may be created for a user. The user profile may also include user preferences, settings, parameters, configurations, settings, limitations, and other applicable information that control what, when, and how data may be collected, analyzed, filtered, culled, and communicated. The user profile may be generated or determined from already available information for the user or based on historical or real-time user actions. For example, the user profile may determine the preferred ways the user analyzes and manipulates search results to achieve desired objectives. In one embodiment, each step may be labeled or tagged for the user to easily perform those same activities and processes in the future. The user's profile may also include any number of settings, configurations, parameters, selections, releases, authorizations, verification requirements, or other information and data that controls how the user's data is utilized in accordance with the illustrative embodiments. The user referenced herein may also refer to one or more individuals, a group of people, a company, an entity, an organization, associated persons, or so forth. The data may also be referred to as investment data, consumer data, private data, monetized data, authorized data, advertising data, or marketing data and may include individual data units, data sets, data pools, and other amalgamations or compilations of data, values, and information.

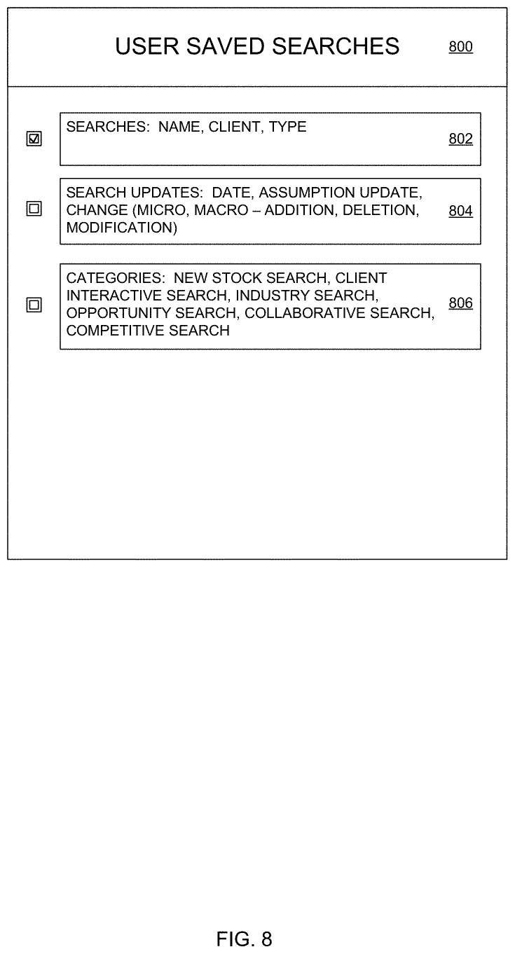

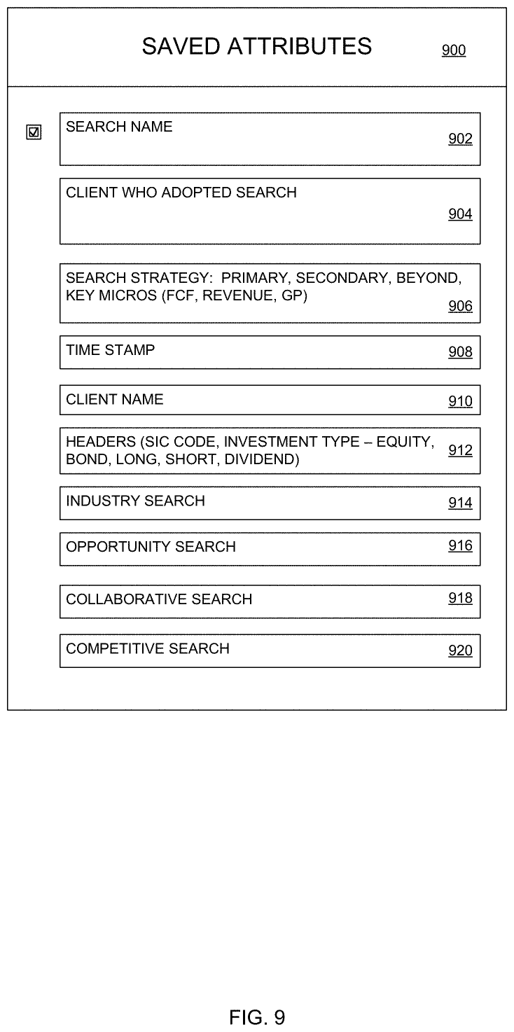

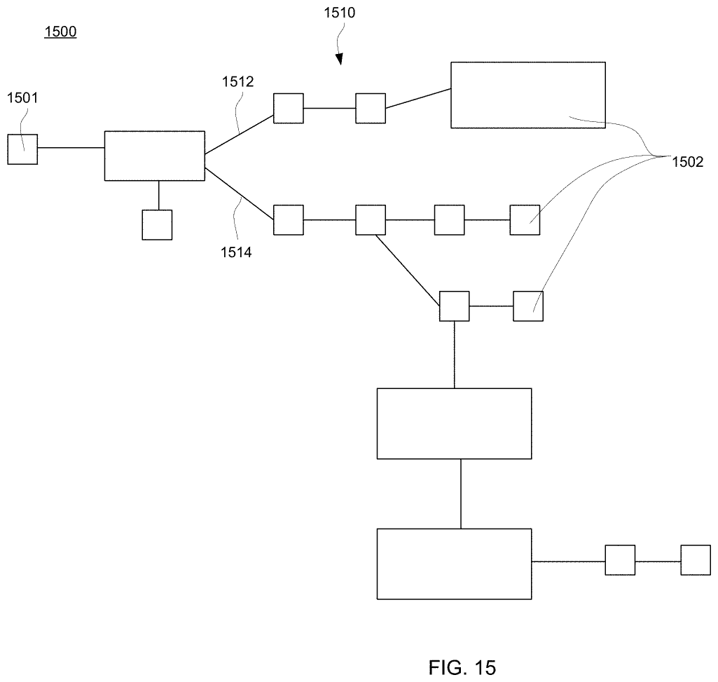

FIG. 8 is a pictorial representation of user saved searches 800 in accordance with an illustrative embodiment. The user saved searches 800 of FIG. 8 and saved attributes 900 of FIG. 9 relate to queries, theories, information, data, parameters, and settings utilized to perform searches and analysis to generate and retrieve investment data. The user saved. searches 800 of FIG. 8 and saved attributes 900 of FIG. 9 may also be represented by the user interface 1500 of FIG. 15. The user saved searches 800 may include information, data, fields, and queries including, but not limited to, searches 802, search updates 804, and categories 806. The searches 802 may specify target information, such as name, client, and type. The searches 802 may also include numeric/tax identifications, industry assigned numbers/codes, categories of products and services, and other applicable information.

The search updates 804 may include information associated with changes, updates, or modifications to applicable search data. For example, the search updates 804 may specify dates, assumption updates, changes (e.g., micro, macro, additions, deletions, modifications, etc.) related to the search. The search updates 804 may show changes in the information previously returned as investment data.

The categories 806 may allow the user to specify one or more of the categories of searches, such as a new stock/equity search, client interactive search, industry search, opportunity search, collaborative search, and a competitive search. Additional categories 806 may include additional investments (e.g., real estate, bonds, funds, etc.), status searches, state-of-the-art searches, and other applicable searches, queries, and research sessions.

FIG. 9 is a pictorial representation of saved attributes 900 in accordance with an illustrative embodiment. The saved attributes 900 may similarly include any number of fields, data, or information. In one embodiment, the saved attributes 900 may include a search name, client who adopted the search 904, search strategy 906, a time stamp 908, a client name 910, headers 912, industry search 914, opportunity search 916, collaborative search 918, and competitive search 920.

The saved attributes 900 may be saved utilizing a search name 902. The search name 902 identifies one or more of the saved attributes for subsequent utilization. The search strategy 906 may include primary, secondary, and micros. The time stamp 908 may indicate when the search was last performed and attributes saved. The client name 910 may indicate the target of the search or the person/group for whom the search was performed. The headers 912 may store relevant information, such as SIC code, investment type (e.g., equity, bond, long, short, dividend, etc.). The type/category of search may also be indicated, such as industry search 914, opportunity search 916, collaborative search 918, and competitive search 920.

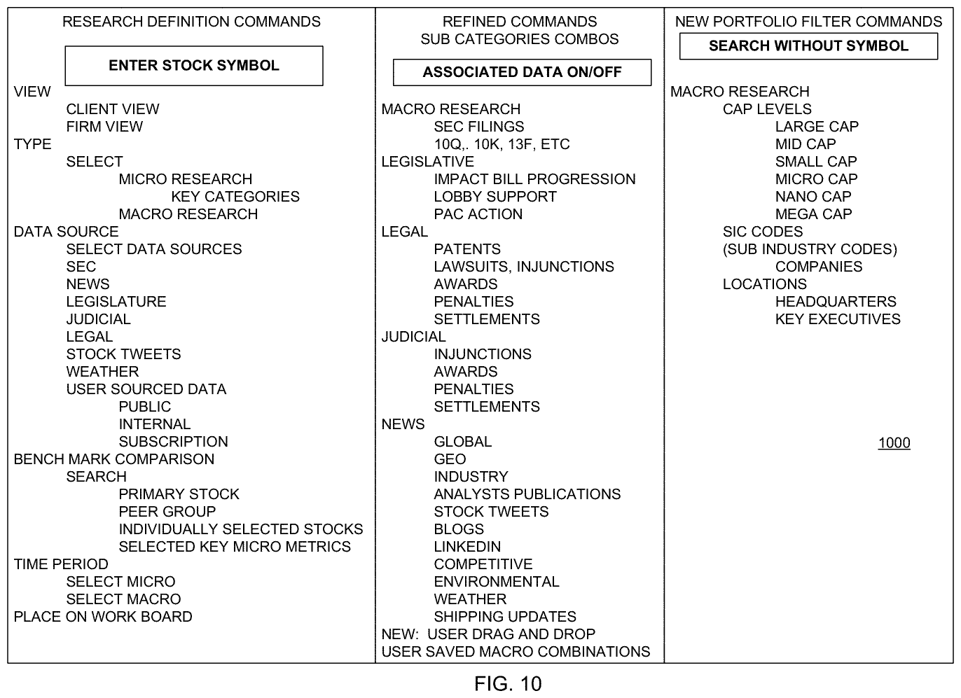

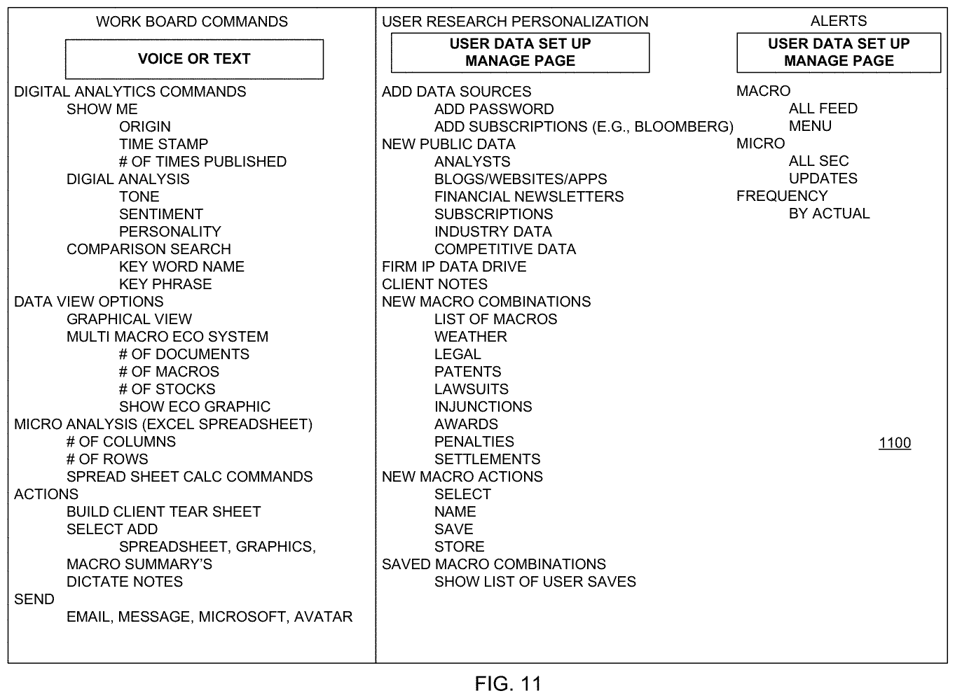

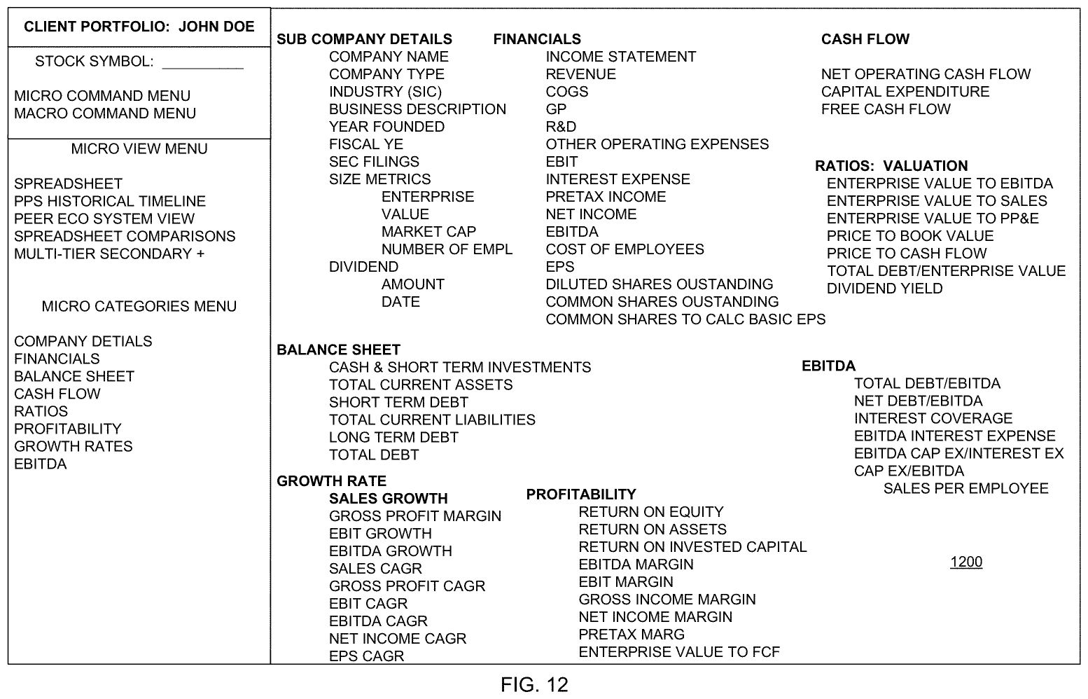

Referring now to FIGS. 10-12 illustrate embodiments of a user interface for generating investment data in accordance with illustrative embodiments. The user interfaces 1000 of FIG. 10, 1100 of FIGS. 11, and 1200 of FIG. 12 may be utilized by one or more mobile applications, personal computers, tablets, e-readers, desktop computers, data platforms, or other devices to communicate and receive information and data and otherwise interact with one or more users. The various user interfaces may also be utilized to rearrange icons, menus, buttons, data, search orders, queries, displays, and other applicable information to more efficiently and quickly process and provide information to authorized users. The user interfaces may include any number of interactive components including icons, hyperlinks, drop down menus, fields, menus, audio, video, hover-based content, downloads, graphics (e.g., tables, spreadsheets, tables, charts, images, etc.) and so forth (these may also be rearranged and reconfigured). The user may select, drag and drop, highlight, or otherwise utilize the user interface 1000. The user may also provide input and receive selections and information audibly, visually, and/or tactilely.

The user interface 1000 may include any number of commands, subcategory information, filters, settings, or other information that may be utilized to retrieve, generate, and modify the applicable investment data. In one embodiment, the user interface 1000 may be displayed at any time during a session or working experience to navigate, retrieve, or modify applicable data.

The user interface 1000 may allow a user to login by providing a username, password, biometrics, and/or other identifying information. The user interface 1000 may allow a user to select from any number of data sources, benchmark comparisons, time periods, and so forth. Relevant information may be saved to a session or placed on a work board. The user interface 1000 may receive user input at any time, such as a stock symbol, company/organization name, alphanumeric identifier, code, description, or free text. In one example, the applicable data sources may include the SEC, news outlets, legislatures, judicial matters, legal reporting, stock tweets, whether, and other user sourced data (e.g., public, internal, subscription). Benchmark comparisons and searches may be performed for a primary stock, peer group, individually selected stocks, selected metrics, or so forth. Any number of time periods may be evaluated whether seconds, minutes, hour, day, month, year, or a combination thereof.

The user interface 1000 may also provide commands and combinations of information for macro research, legislative information, judicial matters, news, and other applicable information. The user interface may link to any number of filings or reports that are available from the SEC, IRS, FTC, FDA, or other governmental or private institutions, such as 10Q, 10K, 13F, and other applicable filings. The legislative information may track existing bills, legislative enforcement, proposed bills, votes in progress, lobbying actions, PAC actions, and other legislative efforts. The legal and judicial information, matters, cases, and details may include patents, lawsuits, injunctions, investigations, penalties, settlements, and other related matters. The news may include global sources, geographic news, analysts/professional publications and sources, stock tweets, blogs, Linkedin, competitive, environmental, weather, and other applicable news and sources.

The user interface 1000 may also allow a user to perform research or filtering by capitalization or category (e.g., large cap, mid cap, small cap, micro cap, nano cap, mega cap, etc.), sub industry codes, and locations (e.g., headquarters, manufacturing, key executives, employees, storage, etc).

FIG. 11 is a pictorial representation of a user interface 1100 for analytics and user customization in accordance with an illustrative embodiment. The user interface 1100 may allow the user to further customize how and when information is presented to the user. For example, the user may customize their work board/session, research preferences, personalization/customization, and alerts.

The user interface 1100 may allow the user to view the origin, time stamp, number of times published, and additional details for content or data sources. The user interface may also present information regarding tone, sentiment, personality of the content or author(s). The user interface 100 may present or allow keyword and phrase analysis to be shown for the content or compared against any number of other sources.

As previously noted, any number or combinations of information may be utilized to generate, review, and modify investment data.

FIG. 12 is a pictorial representation of a user interface 1200 for generating investment data in accordance with an illustrative embodiment. The user interface 1200 may include information and data relevant to one or more targets (e.g., stocks, funds, holdings, investments, collateral, etc.). The user interface 1200 may allow the user to view information as a spreadsheet, timeline, ecosystem view, comparisons, or tiered information. In one embodiment, the user interface 1200 may work with a digital assistant, such as Alexa, Siri, Cortana, or others to receive and process user requests for information, such as “show me micro metrics for TZQ”, or “let's look at Tanzaquit's current financials”, or “show me TZQ's prior quarter and current quarter balance sheets.”

The user interface 1200 may allow the user to view or utilize information, such as company details, financials, balance sheets, cash flow, ratios, profitability, growth rates, EBITDA, and so forth. Additional information relating to company details, financials, balance sheets, cash flow, ratios, profitability, growth rate, and EBITDA may be further shown in the user interface 1200 as shown. For example, company details may include the company name, company type, industry (e.g., SIC code), business description, year founded, fiscal year end data, SEC filings, size metrics (e.g., enterprise, value, market cap, number of employees, locations, etc.), dividends, and so forth. The financials may include information, data, and amounts for income statements, revenue, cost of goods sold (COGS), gross profits, research and development, operating expenses, earnings before interest and taxes (EBIT), interest expense, pretax income, net income, earnings before interest, taxes, depreciation, and amortization (EBITDA), cost of employees, earnings per share (EPS), diluted shares outstanding, common shares outstanding, common shares to calculate basic earnings per share, and so forth. The balance sheet data and information may include cash and short-term investments, total current assets, short term debt, total current liabilities, long term debt, and total debt.

The user interfaces of FIGS. 10-12 may utilize/present any number of command menus to providing input and receiving investment data, information, source content, analytics, graphics, images, and so forth. Any number of document fields may also be presented (e.g., title, topic, parties/businesses involved, author(s), etc.). The document fields may hold numerous documents simultaneously. The user interfaces may also present a bibliography for a user to select and view specific references in real-time. All of the information and data provided by the user interfaces of FIGS. 10-12 may include pop-ups, hover over boxes, or links to the original source content for the user to be able to verify accuracy and analysis provided by the system, method, and data platform.

The following examples of additional information are given as potential data, information, selections, parameters, settings, comparisons, graphics, downloads, that may be received, analyzed, generated, and communicated to the user through one or more of the user interfaces. The cash flow may include net operating cash flow, capital expenditures, and free cash flow. The ratios may include enterprise value to EBITDA, enterprise value to sales, enterprise value to PP&E, price to book value, price to cash flow, total debt/enterprise value, and dividend yield. The profitability may include return on equity, return on assets, return on invested capital, EBITDA margin, EBIT margin, gross income margin, net income margin, pretax margin, and enterprise value to free cash flow (KO. The growth rate may include gross profit margin, EBIT growth, EBITDA growth, sales compound annual growth rate (CAGR), gross profit CAGR, EMT CAGR, EBITDA CAGR, net income CAGR, and EPS CAGR. The EBITDA may include total debt/EBITDA, net debt/EBITDA, interest coverage, EBITDA interest expenses, EBITDA caped expenses/interest expenses capped expenses, capped expenses/EBITDA, and sales per employee.

Additional embodiments may allow the user interface 1200 to retrieve information including: a specified number of quarterly revenue, gross profit, chart trends, average revenue and cross profit per customer, growth trends, amortized free cash flow, free cash flow per customer, free cash flow trends, outstanding debt, the interest, free cash flow run rate to debt load (e.g., quarterly, semiannually, annually, daily, weekly, monthly, etc.), surpluses and shortfall variances, stock trends per time period, debt repayment and restructuring timeframe, and projections of any of the same.

The user interface 1200 may utilize any number of online, form, or downloadable spreadsheets to both communicate and receive applicable investment data. The user interface 1200 and illustrative embodiments may also be utilized to perform a process, such as 1) calculate the estimated revenue projections for a business (e.g., pro forma forecasting), 2) estimate total liabilities and costs, and 3) estimate cash flows. The user interface 1200 may provide investment data applicable to past history, current status, or future or projected time periods, projects, events, or so forth.

The user interface 1200 may process pro formas and other financial statements to analyze and glean investment data. For example, the user interface 1200 may retrieve extensive information from the pro forma for analysis, such as estimated net revenues, price per share (PPS), cash flows, taxes, future income (e.g., net, gross, adjusted, etc.), loans/lines of credit, and expenses. The analysis of pro forma is may be particularly useful when looking forward to changes based on acquisition, merger, changes in capital structure, new capital investment, restructuring, and other significant changes. The user interface 1200 may analyze pro formas for merger and acquisition synergies, GAAP vs. Non-GAAP information (e.g., off-balance-sheet, goodwill, etc.), capital investment, return on investment (ROI) projections, cash flow projections, net income projects, and so forth.

The user interface 1200 may also display information applicable by industry and ranking. For example, user selected micro metrics may be utilized for healthcare service companies to sort, rank, filter, and arrange the companies by dividend, show the top ranked companies from top to bottom, perform ranking by time period, sort the companies by capitalization (e.g., small cap, mid cap, large cap, etc.), rank the companies based on moving averages or other criteria, industry performance metrics, earnings-per-share, price earnings ratio, price-to-book, debt equity ratio, free cash flow, operating profit margin, return on equity, and other applicable information and data. The user interface 1200 may also retrieve industry reviews, blots, analyst opinions, industry papers, newsletters, database entries/profiles, and other applicable information.

The illustrative embodiments may allow content or requests to be imported in any number of ways. Any number and types of content may be utilized with the illustrative embodiments. The embodiments may be able to use a drag and drop function to add new content for analysis. For example, spreadsheets, reports, calculations, and other information may be imported, recognized, dragged and dropped, or otherwise made available. The illustrative embodiments may utilize optical character recognition (OCR), digital character recognition, or other similar processes to convert files, images, PDFs, different file formats, into data, information, and formats usable by the platform.

The illustrative embodiments may be utilized as tools for individuals, investment firms, companies, and other interested parties. The data platform may utilize machine learning and artificial intelligence to learn from skilled analysts and then duplicate their work to save time and money. Research, filtering, and modification processes may be saved and stored for subsequent use with additional targets (e.g., stocks, real estate, investments, etc.).

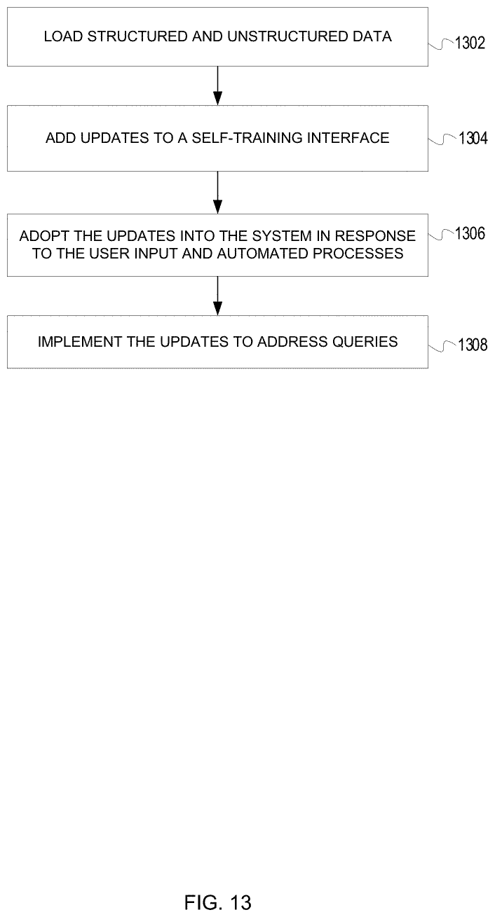

FIG. 13 is a flowchart of a process for updating the system in accordance with an illustrative embodiment. As previously noted, the systems and methods (e.g., FIGS. 1-14) may represent one or more data, investing, or specialized processing and analytics platforms. The process may begin by loading structured and unstructured data. (step 1302). In one embodiment, the structured and unstructured data may be retrieved from any number of sources, services, and content providers. The structured and unstructured data may also be retrieved and loaded by individual users. The system may store the different types of data in one or more databases, memories, servers, or other storage devices.

Next, the system adds updates to a self-training interface (step 1304). The updates may include data files, routines, sets of instructions/sub instructions, macros, algorithms, processes, data sets, software patches, software updates, and so forth. The self-training interface may be utilized to ensure that the user may customize their experience and results. The system may have updates automatically or in response to user input and feedback. For example, the system may utilize machine learning and or artificial intelligence to generate the updates. The system may utilize ratings, rankings, and feedback from multiple users across multiple instances of the system to perform cognitive training and personalization of the system.

Next, the system adopts the updates into the system in response to the user input and automated processes (step 1306). As noted, the updates may include data sets and data tiles that are deployed into the system. The updates may be integrated as software updates to the platform. The updates may represent new code, upgraded code, replacement code, and/or versioning of the software utilized by the system. Updates are implemented frequently to update the analysis and processes utilized by the system to address queries that are input into the system. The process of FIG. 13 may be performed recursively for numerous users, instances, and even integrated systems. The system may be activated and reactive to users, clients, markets, and other applicable data, information, conditions, and scenarios.

Next, the system implements the updates to address queries (step 1308). The updates may be implemented so that basic data, such as a company name, may be quickly expanded to a full set of queries, searches, displays, and data retrievals. As a result, information associated with the company, individual, entity, group, or ticker may be generated in a desired user interface layout. The user interface may present information and data in a specified order. The implementations may be implemented as a script, algorithm, program, or other process.

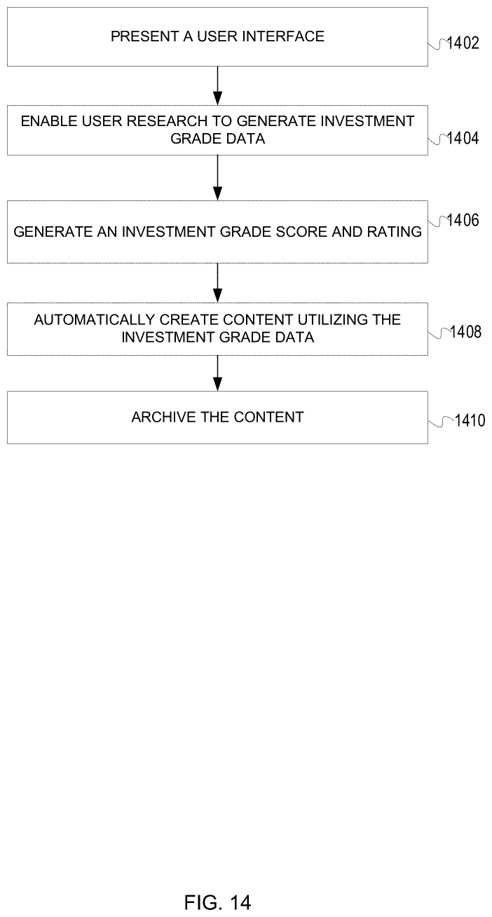

FIG. 14 is a flowchart of a process for generating investment grade data in accordance with an illustrative embodiment. In one embodiment, the process may begin by presenting a user interface (step 1402). The user interface may include a dashboard, tack board, or working interface for managing the applicable queries, information, data, and content. For example, the user may place targets or queries, such as thumbnails of user selected micro and macro researched documents on a tack board for review.

Next, the system enables user research to generate investment grade data (step 1404). The targets may be populated for a thorough review in a large scale. For example, the user may be enabled to review and compare documentation (e.g., data, information, content, documents, filings, research, etc), and documents may be selected, deleted, labelled, or otherwise marked. Step 1404 may be performed at any time during the process of FIG. 14. In one embodiment, the research may be automatically performed in response to user input, documents, thumbnails, or other data and information from a user or another system.

Next, the system generates an investment grade score and rating (step 1406). Any number of steps may be performed during step 1404. For example, a proprietary data analytics score may be applied to each research and analytics document and automatically populated onto a review board, the system automatically breaks all documents into their essential components and parts and calculates a data quality rating using applicable algorithms, processes, steps, and logic (as outlined herein) for each component, the components are automatically recombined to calculate a summation score comprised of each score for the essential components to generate an overall research and analytics rating corresponding to the investment grade rating and score, the latest price (e.g., stock, bond, equity, property) is populated for each investment being researched, and a time stamp is compared to the latest price to ensure time sensitive accuracy. Rankings for distinct resources and data may also be performed to further separate and delineate applicable data based on the scores and other information (e.g., reliability of sources, past performance, etc.).

Next, the system automatically creates content utilizing the investment grade data (step 1408). The content may be created utilizing the score, rating, and ranking process previously performed. Portions of the investment grade data may be highlighted, prioritized, removed, culled, or otherwise processed automatically by the system or in response to user input. In one embodiment, documents or documentation, such as PDFs, spreadsheets, or word processing documents may be automatically created for communication or distribution to relevant parties (e,g clients, managers, investors, etc.). The content may include a common language explanation of the research performed, analytics conducted, the rating and score applied to each research document (and components), the overall score, a certified time stamp, and the signature of the registered investment advisor (RIA). Step 1408 may be utilized to effectively communicate all relevant research, analytics, ratings, scores, rankings, and processes to relevant parties. The communications may be performed by email, text message, fax message, in-application messages, secured links, secured web interfaces, and so forth. All communications may also be time stamped to provide a verifiable and authenticated record. For example, the communications are compliant with SEC client communications requirements (e.g., RIA, enterprise, etc.).

Next, the system archives the content (step 1410). The documentation may be stored within the platform database capturing all details of the data and information communicated to the client. The archived content may be audit compliant, user searchable (e.g., query/target, client, analyst, RIA, resources, etc.), enterprise searchable, and may be attached to a client period end statement. The process utilized to create the content may also be saved for duplication in the future for other targets, queries, and documents. The documents, content, and data utilized in FIG. 14 may utilize best practices and may follow industry, governmental, and other legal standards.

FIG. 15 is a pictorial representation of a user interface for implementing queries in accordance with an illustrative embodiment. The user interface 1500 may represent one or more queries or searches that are performed in real-time, historical queries, automatic queries, or future queries. The user interface 1500 may represent a query map 1510 performed manually, semi-automatically, or automatically. The user interface 1500 may represent a two-dimensional space (i.e., infinite paper) available for displaying one or more user queries, content, analysis, and results that may be saved for utilization at any time. The user interface 1500 may alternatively be presented in three-dimensional space (e.g., virtual reality, augmented reality, holographically, etc).

The query map 1510 may include any number of nodes 1502. The nodes 1502 may represent additional searches, requests, or processes performed as associated with an initial node 1501 For example, the initial node 1501 may represent a company name, stock ticker, individual name, request, or other information as herein disclosed.

In one embodiment, the query map 1510 may be utilized to recreate a search manually performed by a user before including numerous settings, parameters, requests, sources, and so forth. The query map 1510 may then automatically repeated for the same or distinct initial nodes 1501 (e.g., target companies, tickers, etc.) user interface 1500 may then be performed. The query map 1510 may be saved as a template for utilization by any number of users. The query map 1510 may also be sold to individual investors. The query map 1510 may display any number of pop-ups, reports, or other information.

Branches of the query map 1510 may be added or removed as needed. For example, branch 1512 may be removed from the query map 1510 with only branch 1514 and the subsequent branches remaining. Any of the nodes 1502 may also be removed or changed at any time. Extensive information may be displayed within the nodes 1502, by hovering over the nodes 1502, by selection the nodes 1502, zooming in on the nodes 1502, or so forth.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications mediums.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider),

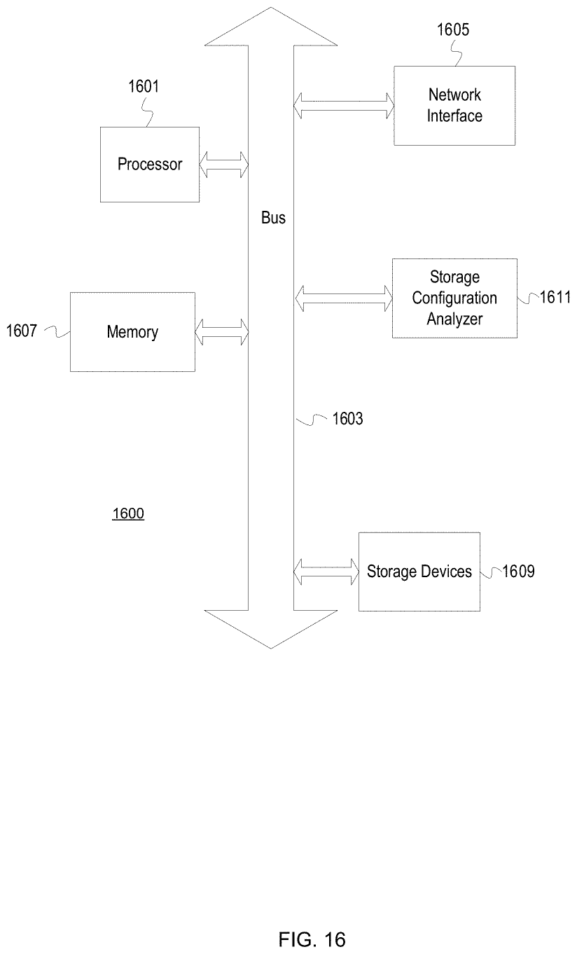

FIG. 16 depicts a computing system 1600 in accordance with an illustrative embodiment. For example, the computing system 1600 may represent a device, such as one or more of the devices 101 of FIG. 1. The computing system 1600 includes a processor unit 1601 (possibly including multiple processors, multiple cores, multiple nodes, and/or implementing multi-threading, etc.). The computing system includes memory 1607. The memory 1607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 1603 (e.g., PCI, ISA, PCI-Express, HyperTransport®, InfiniBane®, NuBus, etc.), a network interface 1605 (e.g., an ATM interface, an Ethernet interface, a Frame Relay interface, SONET interface, wireless interface, etc.), and a storage device(s) 1609 (e.g., optical storage, magnetic storage, etc.). The system memory 1607 embodies functionality to implement embodiments described above. The system memory 1607 may include one or more functionalities that store investment data, content, parameters, applications, user profiles, and so forth. The memory 1607 or other storages of the computing system 1600 may be managed by the storage configuration analyzer 1611. Code (e.g., algorithms, scripts, sets of instructions, user interfaces, programs, applications, etc.) may be implemented in any of the other devices of the computing system 1600. Any one of these functionalities may be partially (or entirely) implemented in hardware and/or on the processing unit 1601. For example, the functionality may be implemented with an application specific integrated circuit, in logic implemented in the processing unit 1601, in a co-processor on a peripheral device or card, etc. Further, realizations may include fewer or additional components not illustrated in FIG. 16 (e.g., video cards, audio cards, additional network interfaces, peripheral devices, etc.). The processor unit 1601, the storage device(s) 1609 and the network interface 1605 are coupled to the bus 1603. Although illustrated as being coupled to the bus 1603, the memory 1607 may be coupled to the processor unit 1601.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A platform for monetizing investment data, comprising:
a plurality of electronic devices executing a data application, the data application is configured to capture user data associated with a user; and
a data platform accessible by the plurality of electronic devices executing the data application through one or more networks, wherein the data platform receives one or more user identifications for a user, authenticates the user, receives one or more user queries, retrieves content associated with the one or more user queries including the investment data, displays the content in a continuous display in which the user is enabled to view any of the content generated during a session by zooming, scrolling, or rotating in multiple dimensions, receives revisions to the one or more queries, retrieves revised content associated with the revisions including revisions to the investment data, and displays the revised content in the continuous display and saving the previous content.

2. The platform of claim 1, wherein the content is retrieved from a plurality of public sources and private sources including structured and unstructured data.

3. The platform of claim 2, wherein the private sources include one or more subscription services.

4. The platform of claim 1, wherein the continuous display enables the user to modify any portion of the session during utilization, and wherein the plurality of electronic devices are charged to access the content and revised content.

5. The platform of claim 1, wherein the content associated with the one or more user queries is retrieved utilizing user preferences associated with the user.

6. The platform of claim 1, wherein the one or more queries are saved for subsequent utilization.

7. The platform of claim 1, wherein the data platform automatically rates and scores the content and the revised content.

8. The platform of claim 7, wherein components of the content and revised content are rated with a score and ranked.

9. The platform of claim 8, wherein the data platform automatically generates documentation including the revised content.

10. The platform of claim 9, wherein the documentation complies with audit standards.

11. The platform of claim 9, wherein the documentation is searchable.

12. The platform of claim 9, wherein the content, revised content, and documentation is time stamped.

13. A platform for monetizing investment data, comprising:
a plurality of electronic devices executing a data application, the data application is configured to capture user data associated with a user; and
a data platform accessible by the plurality of electronic devices executing the data application through one or more networks in response to paid access, wherein the data platform receives one or more user queries, searches public and private databases and resources with defined data structures utilizing the one or more user queries, searches unstructured data utilizing the one or more user queries, culls portions of the investment data retrieved in response to searching the defined data structures and unstructured data, and sorts the investment data by rating and ranking the investment data.

14. A data platform, comprising:
a processor for executing a set of instructions;
a memory for storing the set of instructions, wherein the set of instructions are executed to:
receive one or more user identifications for a user, authenticate the user, receive one or more user queries, retrieve content associated with the one or more user queries including the investment data, display the content in a continuous display in which the user is enabled to view any of the content generated during a session by zooming, scrolling, or rotating in multiple dimensions, receive revisions to the one or more queries, retrieve revised content associated with the revisions including revisions to the investment data, and display the revised content in the continuous display and saving the previous content.

15. The data platform of claim 14, wherein the data platform stores the content in one or more databases associated with the data platform.

16. The data platform of claim 14, wherein the data platform communicates with a plurality of electronic devices executing a data application, the plurality of electronic devices communicate with the data platform through one or more networks.

17. The data platform of claim 14, wherein the set of instructions are further executed to generate branches in the content associated with the revised content in response to receiving the revisions.

18. The data platform of claim 14, wherein the set of instructions are further executed to perform an investment action in response to the content or the revised content.

19. The data platform of claim 14, wherein the one or more queries are based on documents imported by a user.

20. The data platform of claim 14, wherein the set of instructions are further executed, to rate the content and the revised content with a score.

21. The data platform of claim 14, wherein the set of instructions are further executed to generate documentation including the revised content, and wherein the documentation complies with audit standards and is searchable.
